(19) United States
(12) Patent Application Publication
(10) Pub. No.: US 2011/0313143 A1
(43) Pub. Date: Dec. 22, 2011

(54) NUCLEIC ACID PURIFICATION APPARATUS AND METHOD

(75) Inventors: Philip Martin, Carlsbad, CA (US); Eric Olivares, Union City, CA (US); Byung-In Lee, Encinitas, CA (US); Timothy Powers, Carlsbad, CA (US); Joe Meyer, San Diego, CA (US)

(73) Assignee: LIFE TECHNOLOGIES CORPORATION, Carlsbad, CA (US)

(21) Appl. No.: 13/139,726

(22) PCT Filed: Dec. 15, 2009
(86) PCT No.: PCT/US09/68130

§ 371 Date: Sep. 1, 2011

Related U.S. Application Data
(60) Provisional application No. 61/122,685, filed on Dec. 15, 2008.

(51) Int. Cl. C07H 21/04; C12M 1/00; B01J 19/00

(52) U.S. Cl. 536/23.1; 422/534; 422/535; 422/527; 435/283.1

(57) ABSTRACT

Provided herein is a clarification/binding device for the isolation of at least one target molecule from a sample. The clarification/binding device can comprise an clarification column and a binding column. The clarification column can be configured to receive the sample. Further, the clarification column can comprise a filter configured to filter at least one non-target molecule from the sample. The binding column can be configured to receive the filtered sample from the clarification column. The binding column can comprise a binding material for binding at least one target molecule. The clarification/binding device can be configured to filter the sample and bind at least one target molecule under negative pressure. Further provided herein is an apparatus for the isolation of a target molecule from a sample. The apparatus can comprise a top plate and a vacuum manifold comprising a first chamber and a second chamber. The top plate can be configured to be used with one or both of the first vacuum chamber and the second chamber of the vacuum manifold. Further provided herein are methods of use of the clarification/binding device and the vacuum apparatus and kits comprising the clarification/binding device and vacuum apparatus.

### FIELD OF THE INVENTION

The invention provided herein relates to the rapid isolation and collection of nucleic acids and other molecules from cell lysates and other liquid mixtures.

### BACKGROUND OF THE INVENTION

In biochemical and biological procedures, it is often desirable to isolate and collect a molecule from a liquid mixture or sample. This can be achieved by first filtering the liquid mixture followed by capturing the desired molecule from the filtered liquid using a material that selectively binds to the molecule. The molecule is then eluted from the binding material and collected. Currently, such procedures require multiple steps and devices to carry out the isolation, binding and collections steps. For example, plasmid purification from bacteria typically involves the generation of a cell lysate containing soluble plasmid material and insoluble protein and genomic DNA particles. The lysate is clarified by removing the insoluble particulate material, typically by centrifugation or by a filtration device. The clarified lysate is then transferred to a binding resin or a binding column which binds the desired plasmid DNA. The target DNA is then eluted from the binding resin or binding column and collected.

Clarification of cell lysates and elution of plasmid DNA are widely practiced in the art, and the market has provided numerous solutions to simplify and speed up the clarification or elution process (syringes as in Qiagen QIAfilter kits or Sigma GenElute™ kits, spin columns as in Invitrogen S.N.A.P.™ kits, or gravity flow filter baskets as in Invitrogen Purelink™ HiPure kits). However, currently available products in the art require one or more time consuming gravity filtration steps or centrifugation steps, which are inefficient and require additional instruments or devices. Clarification via centrifugation itself remains laborious and time consuming, often taking up to 45 minutes and often requiring multiple spins.

Vacuum manifolds can be used to facilitate the clarification of a sample. Vacuum manifolds typically fall within two general design categories. The first type of vacuum manifold consists of a molded plastic base with top mounted luer attachments to allow attachment of multiple columns (such as the Promega Vac-Man® Laboratory Vacuum Manifold). These manifolds are designed to be used in conjunction with spin column vacuum protocols involving centrifugation. The second type of vacuum manifold has a removable top plate for 96 well plate fittings (such as Macherey-Nagel (Düren, Germany)). In current methods of purifying and collecting plasmid DNA, these types of traditional vacuum manifolds are not configured for or used for each of the filtering, binding, washing, and eluting steps.

Therefore, it would be desirable to develop an adaptable method and apparatus for filtering a liquid mixture followed by selectively binding a desired molecule in the mixture and collecting the bound material. It would be further desirable to have a method and apparatus which can clarify a sample and bind a target molecule simultaneously to reduce processing time.

### SUMMARY OF THE INVENTION

Provided herein is a clarification/binding device for isolation of at least one target molecule from a sample comprising a clarification column and a binding column. In some embodiments, the clarification/binding device can be a dual column clarification binding device, with the clarification column nested in the binding column. The clarification column can be configured to receive the sample. The clarification column can comprise at least one filter configured to filter at least one non-target molecule from the sample. The binding column can be configured to receive the filtered sample from the clarification column. Additionally, the binding column can comprise a binding material for binding at least one target molecule. The clarification/binding device can be configured to filter the sample and bind the target molecule under negative pressure. In some embodiments, the binding column can further comprise at least one support structure in communication with the binding material. The support structure can be configured to restrict movement of the binding material with respect to the binding column. In some embodiments, at least one support structure is a frit. Furthermore, the binding column can further comprise at least one locking ring. The locking ring can be configured to restrict the movement of the binding material. In some embodiments, the binding material can be configured to bind a nucleic acid. The nucleic acid can be deoxyribonucleic acid (DNA), such as, for example, plasmid DNA or fragments thereof, or genomic DNA, or fragments threof. The binding material can be at least one of silica, glass fiber, nitrocellulose, a charge switch membrane, an anion exchange matrix, and derivatized glass fiber, or combination thereof. In some embodiments, the binding material comprises at least two layers, a first layer and a second layer. The first layer and the second layer can have a pore size in the range of between 0.5 um to 5 um. In some embodiments, the binding material comprises multiple layers. The binding material can comprise a material having a pore size in the range of between 0.6 um to 2 um. In some embodiments, the pore size is in the range of between 0.7 um and 1 um. The device provided herein further comprises a filter wherein the filter can be configured to clarify the sample. In some embodiments, the filter can comprise at least two layers, a first layer and a second layer. The first layer and the second layer can be part of the same structure. Alternatively, the first layer and the second layer can be two separate structures. The filter can be an asymmetric filter. In such an embodiment, the pore size in the first layer of the filter is different from the pore size of the second layer of the filter. Alternatively, the first and second layers of the filter can have the same pore size. The device can comprise a first layer having a pore size in the range of between 5 um and 20 um and the second layer can have a pore size in the range of between 30 um and 100 um. In some embodiments, the first layer can have a pore size in the range of between 5 um and 7 um and the second layer can have a pore size in the range of between 40 um and 45 um. In some embodiments, the filter can comprise more than two layers. In some embodiments, the filter can be a rigid structure, such as, for example, a two layer polyethylene frit. Alternatively, the filter can be a flexible membrane. In such an embodiment, the device can further comprise a support for the flexible membrane. The support can be a frit. In some embodiments, the clarification column can further comprise a locking ring. Additionally, the device can be configured to elute the target molecule(s) from the binding material under negative pressure. The negative pressure can be created by a vacuum source or venture. In some embodiment, the negative pressure can be created by a centrifuge. The clarification column can, in some embodiments, further comprise a clarification column depth stop configured to limit the depth of insertion of the clarification column into the binding column. Additionally, the binding column can further comprise a binding column depth stop, the binding column depth stop configured to limit the insertion of the device into a centrifuge tube. In some embodiments, the sample is a lysate. In some embodiments the binding column can further comprise a luer nozzle.

Further provided herein is an apparatus for the isolation of a target molecule from a sample. The apparatus can comprise a top plate and a vacuum manifold. The top plate can be configured to hold at least one container for isolating at least one type of target molecule from a sample. In some embodiments, the container can isolate more than one type of target molecule. The vacuum manifold can comprise a first vacuum chamber and a second vacuum chamber. The top plate can be configured to be used with one or both of the first vacuum chamber and the second vacuum chamber of the vacuum manifold. The container to be held by the top plate can comprise a clarification/binding device according to any of the clarification/binding devices provided herein. Furthermore, in some embodiments the apparatus can comprise a removable waste tray. Additionally, the apparatus can comprise a removable elution tray. The removeable elution tray can be configured to hold at least one collection tube. In some embodiments, the elution tray can be configured to hold an eluted sample from a multiwell collection plate. The multiwell plate can be a 96-well multiwell plate. In some embodiments, the apparatus can further comprise at least one support structure. The support structure can be configured to support a multiwell plate. The apparatus can comprise a top plate. The top plate can be a mini column top plate or a midi/maxi column top plate. In an embodiment where a midi/maxi top plate is used, the apparatus can further comprise a stop plate configured to control the depth the device is inserted into the apparatus. In some embodiments, the top plate can further comprise at least one luer connector. Furthermore, in some embodiments, the apparatus can further comprise a sealing member. The sealing member can be configured to facilitate forming a seal between the top plate and either the first vacuum chamber or the second vacuum chamber. The sealing member can be configured to facilitate forming a seal between the top plate and both the first and second vacuum chambers of the vacuum manifold. The seal formed can be an airtight seal. Alternatively, the seal can be a partial seal. The sealing member can be located on the vacuum manifold. Alternatively, the sealing member can be located on the top plate. In some embodiments, the apparatus can further comprise at least a third vacuum chamber. Additionally, the apparatus can further comprise more than one top plate. In some embodiments, the apparatus can further comprise a vacuum control unit, wherein the vacuum control unit can comprise at least one of a fine control valve, a quick release valve, and a pressure gauge.

Also provided herein are methods for isolating at least one target molecule from a sample. In some embodiments of the method, the method comprises: introducing a sample to a clarification/binding device; applying negative pressure to the clarification/binding device to clarify the sample and subsequently bind at least one target molecule to the binding material. In some embodiments of the method, the device can comprise a clarification/binding device according to any of devices provided herein. Furthermore the method can further comprise removing the clarification column from the device. In some embodiments of the method, the binding column can be washed once. In some embodiments, the binding column can be washed more than once. In some embodiments of the method, the method can further comprise eluting the at least one target molecule bound to the binding material. The at least one eluted target molecule can be collected. In some embodiments, the at least one eluted target molecule can be collected in at least one collection tube. In some embodiments, the at least one eluted target molecule can be collected in a multiwell collection plate. In some embodiments of the method, the applying of negative pressure can further comprise inserting the device into a top plate on the manifold. In some embodiments, of the method, the applying negative pressure further comprises centrifuging the clarification/binding device.

Yet another method provided herein comprises a method of isolating at least one target molecule comprising introducing a sample to a clarification/binding device; applying negative pressure to the clarification/binding device to clarify the sample and bind at least one target molecule to the binding material; removing the clarification column from the device; and eluting the at least one target molecule from the device. In some embodiments, the introducing of the sample, applying negative pressure to the device, removing the clarification column from the device, and the eluting of the target molecule can all be performed using a single vacuum chamber of a vacuum manifold. Furthermore, the method can further comprise washing the binding column at least once after removing the clarification column from the device. In some embodiments, the introducing, applying, removing and optional washing can be performed using a first chamber of a vacuum manifold. The devices can then be put in communication with the second chamber of the vacuum manifold. The eluting can then be performed using the second chamber of the vacuum manifold. Additionally, the method can further comprise washing the binding column at least once after removing the clarification column. The washing step can be performed using the first vacuum chamber. In some embodiments of the method, the at least one eluted target molecule can be collected. In some embodiments, the at least one target molecule can be collected in a collection tube or collection tubes. The target molecule can be collected in any suitable container for collecting the eluted target molecule.

Yet another embodiment of the method provided herein is a method of isolating at least one target molecule from a sample using a clarification/binding device and a vacuum chamber manifold. In some embodiments, the method can comprise: introducing a sample to a clarification/binding device. The clarification/binding device can comprise a clarification column and a binding column. The clarification/binding device can then be inserted into an opening in a top plate. The top plate can then be positioned over a first vacuum chamber of a vacuum chamber manifold. Negative pressure supplied by the vacuum manifold can then be applied to the clarification/binding device to clarify the sample. The clarification column can clarify the sample. Immediately after the sample is clarified, the at least one target molecule present in the clarified sample can be bound inside the binding column. The at least one target molecule can be bound to a binding material present in the binding column. After the clarified sample has been passed through both columns of the device, the clarification column can be removed from the binding column. Negative pressure can be applied again to then elute the at least one target molecule from the binding column. In some embodiments of the method, the applying of negative pressure to clarify the sample and bind the target molecule or molecules and the applying of negative pressure to elute the bound at least one target molecule can be performed using the same vacuum chamber of a vacuum manifold. Alternatively, the application of negative pressure to clarify the sample and to bind the at least one target molecule can be performed using a first vacuum chamber of a vacuum chamber manifold. The application of negative pressure to elute the at least one target molecule can be performed using a second vacuum chamber of the vacuum chamber manifold. In some embodiments of the method, the method can further comprise washing the binding column at least once after removing the clarification column from the device and prior to elution. In some embodiments, the negative pressure supplied to clarify and bind the sample and/or to elute the target molecule from the binding column can be supplied using a centrifuge and may be in the form of centripetal force. In such cases, the “negative pressure” is not negative per se and is instead the driving force caused by the centrifuge to drive the sample or the elution or other buffer through the relevant column or columns of the clarification/binding device.

Yet in another embodiment of the method, the method can comprise inserting the clarification/binding device into an opening in the top plate of a vacuum manifold apparatus. In some embodiments, the top plate can then be positioned on the vacuum manifold apparatus. Alternatively, the top plate is already positioned on the vacuum manifold prior to the insertion of the clarification/binding devices. The sample can be introduced to the clarification/binding device. The clarification/binding device can comprise a clarification column and a binding column. Negative pressure supplied by the vacuum manifold can then be applied to the clarification/binding device to clarify the sample. The clarification column can clarify the sample. Immediately after the sample is clarified, the at least one target molecule present in the clarified sample can be bound inside the binding column. The at least one target molecule can be bound to a binding material present in the binding column. After the clarified sample has been passed through the device, the clarification column can be removed from the binding column. Negative pressure can be applied again to then elute the at least one target molecule from the binding column. In some embodiments of the method, the applying of negative pressure to clarify the sample and bind the target molecule or molecules and the applying of negative pressure to elute the bound at least one target molecule can be performed using the same vacuum chamber of a vacuum manifold. Alternatively, the application of negative pressure to clarify the sample and to bind the at least one target molecule can be performed using a first vacuum chamber of a vacuum chamber manifold. The application of negative pressure to elute the at least one target molecule can be performed using a second vacuum chamber of the vacuum chamber manifold. In some embodiments of the method, the method can further comprise washing the binding column at least once after removing the clarification column from the device. In some embodiments, the negative pressure supplied to clarify and bind the sample and/or to elute the target molecule from the binding column can be supplied using a centrifuge and may be in the form of centripetal force. In such cases, the “negative pressure” is not negative per se and is instead the driving force caused by the centrifuge to drive the sample or the elution or other buffer through the relevant column or columns of the clarification/binding device.

Further provided herein are kits for isolating a target molecule of interest from a sample. In some embodiments, a kit for isolating a target molecule of interest can comprise a clarification/binding device for isolation of at least one target molecule from a sample comprising: a clarification column configured to receive the sample, the clarification column comprising at least one filter configured to filter at least one non-target molecule from the sample, and a binding column configured to receive the filtered sample from the clarification column, the binding column comprising a binding material for binding at least one target molecule, said clarification/binding device configured to filter the sample and bind the target molecule under negative pressure; and at least one elution buffer. In some embodiments, the elution buffer can comprise Tris hydrochloride. In some embodiments, the kit can further comprise a resuspension buffer. In some embodiments, the resuspension buffer can comprise TrisHCL and EDTA. Furthermore, the kit can comprise at least one wash buffer. In some embodiments, the kit can comprise a neutralizing buffer. In some embodiments of the kit, the kit can further comprise a lysis buffer. The lysis buffer can comprise sodium hydroxide and sodium dodecylsulfate. In some embodiments of the kit, the kit can further comprising an RNase A stock solution. In some embodiments, the kit can further comprise a vacuum manifold apparatus.

Another embodiment of a kit provided herein is a kit for isolating a target molecule of interest comprising: a clarification/binding device for isolation of at least one target molecule from a sample comprising: a clarification column configured to receive the sample, the clarification column comprising at least one filter configured to filter at least one non-target molecule from the sample, and a binding column configured to receive the filtered sample from the clarification column, the binding column comprising a binding material for binding at least one target molecule, said clarification/binding device configured to filter the sample and bind the target molecule under negative pressure; at least one lysis buffer; at least one RNase stock solution; at least one resuspension buffer; at least one neutralization buffer; at least one wash buffer; and at least one elution buffer. In some embodiments, the kit can further comprise a vacuum manifold apparatus.

### BRIEF DESCRIPTION OF THE DRAWINGS

FIG. 1A illustrates an embodiment of a mini dual column clarification/binding device; FIG. 1B is a side view of an embodiment of an clarification column of the dual column clarification/binding device; FIG. 1C is a cross-sectional view of the clarification column; FIG. 1D is a side view of an embodiment of a binding column of a dual column clarification/binding device; FIG. 1E is a cross-sectional view of the binding column;

FIG. 2A illustrates an embodiment of a midi/maxi dual column clarification/binding device; FIG. 2B is a side view of an embodiment of the clarification column of the dual column clarification/binding device; FIG. 2C is a side view of the binding column of the dual column clarification/binding device;

FIG. 3A illustrates a perspective view of an embodiment of a dual chamber vacuum manifold apparatus; FIG. 3B shows an embodiment of a dual chambered vacuum manifold comprising a binding/clarifying and/or washing chamber and an elution chamber wherein the application of negative pressure can be controlled by a single valve; FIG. 3C shows an alternate embodiment of a dual chambered vacuum manifold comprising a binding/clarifying and/or washing chamber and an elution chamber wherein the application of negative pressure can be controlled by more than one valve;

FIG. 4 illustrates a detail view of a vacuum control unit;

FIG. 5 illustrates an embodiment of an elution tray isolated from the apparatus;

FIG. 6 illustrates a top view of an embodiment of a top plate for use with a mini dual column clarification/binding device;

FIG. 7A illustrates a top view of an embodiment of a top plate for use with a midi/maxi dual column clarification/binding device; FIG. 7B is a cross-sectional side view of the top plate in FIG. 7A along the line B-B; FIG. 7C illustrates an embodiment of a stop plate for use with a midi/maxi dual column clarification/binding device;

FIG. 8A illustrates a top view of an embodiment of a top plate for use with luer outlets configured to receive a column having a luer nozzle; FIG. 8B illustrates an embodiment of a luer connector for use with the plate in FIG. 8A;

FIG. 9 illustrates a top view of an embodiment of a vacuum manifold plate collar capable of receiving a multiwell plate;

FIG. 10 illustrates a perspective view of an embodiment of a vacuum manifold apparatus for use with mini dual clarification/binding columns;

FIGS. 11A and 11B illustrate cross-sectional views of a vacuum manifold apparatus for use with mini dual clarification/binding columns; FIG. 11A is a cross-sectional view of the clarifying/binding/washing chamber of a vacuum manifold apparatus configured for use with mini columns; FIG. 11B is a cross-sectional view of the elution chamber configured for use with mini columns;

FIG. 12A illustrates a perspective view of an embodiment of a vacuum manifold apparatus for use with luer valves; FIG. 12B is an embodiment of a luer valve adaptable to be used with the top plate of FIG. 12A;

FIG. 13 illustrates a perspective view of an embodiment of a vacuum manifold apparatus for use with a midi/maxi dual clarification/binding columns;

FIGS. 14A and 14B illustrate cross-sectional views of a vacuum manifold apparatus for use with midi/maxi dual clarification columns; FIG. 14A is a cross-sectional view of the clarifying/binding/washing chamber of a vacuum manifold apparatus configured for use with midi/maxi columns; FIG. 14B is a cross-sectional view of the elution chamber configured for use with midi/maxi columns; and

FIG. 15 illustrates a perspective view of an embodiment of a vacuum manifold apparatus adaptable for use with a multiwell plate;

FIGS. 16A-16C illustrate an embodiment of a vacuum manifold apparatus for use with a multiwell plate; FIG. 16A is a cross-sectional view of a configuration of a vacuum manifold apparatus for clarifying samples using multiwell plates; FIG. 16B is a cross-sectional view of a configuration of a vacuum manifold apparatus for binding nucleic acids and washing a multiwell plate; FIG. 16C is a cross-sectional view of a configuration of a vacuum manifold apparatus for eluting nucleic acids from a multiwell plate.

Additional features and advantages of the present devices and methods may be obtained by reference to the following detailed description and accompanying drawings that set forth illustrative embodiments, in which the principles of the methods, devices and apparatuses are utilized.

### DETAILED DESCRIPTION OF THE INVENTION

### I. Definitions

Unless defined otherwise, all technical and scientific terms used herein have the same meaning as commonly understood by one of ordinary skill in the art to which this invention belongs. Generally, the nomenclature used herein are well known and commonly employed in the art. Terms of orientation such as “up” and “down”, “top” and “bottom”, “above” and “underneath” or “upper” or “lower” and the like refer to orientation of parts during use of a device. Where a term is provided in the singular, the inventors also contemplate the plural of that term. Where there are discrepancies in terms and definitions used in references that are incorporated by reference, the terms used in this application shall have the definitions given herein. As employed throughout the disclosure, the following terms, unless otherwise indicated, shall be understood to have the following meanings.

The term “mini preparation” or “mini prep” as used herein refers to a scale of purification from a starting culture volume of approximately 0.5-5 ml. Columns and other devices used in mini prep purification can also range from approximately 0.5 ml to approximately 5 ml. The term “midi/maxi preparation” or “midi/maxi prep” refers to a scale of purification starting from a culture volume of 5-100 ml. Columns and other devices used in midi prep purification can range from approximately 5 ml to approximately 15 ml or from approximately 5 ml to approximately 25 ml, and columns and other devices used in maxi prep purification can range from approximately 25 ml to approximately 100 ml.

The term “column” and “columns” as used herein refers to a device or container able to hold a liquid. While columns generally refer to devices and containers having approximately cylindrical shapes, it is understood that that the term “column” as used herein can refer to devices or containers having any shape, including but not limited to predominantly spherical, pyramidal, rectangular, irregular shapes and combinations thereof.

The term “protein” or “proteins” as used herein include full length proteins, protein fragments, proteins in their native state or denatured proteins. Mixture of proteins can be a mixture of full length proteins, a mixture of protein fragments, or a mixture of full length proteins and protein fragments. Proteins can be acidic or basic, and can be purified as a mixture from cell lysates.

The term “nucleic acid” as used herein includes both DNA and RNA without regard to molecular weight or source. Nucleic acids include the full range of polymers of single or double stranded nucleotides, including chemically modified nucleotides, as known in the art that are capable of forming base pairs, joinable with other nucleic acids, and cleavable by processes described herein. A nucleic acid typically refers to a polynucleotide molecule comprised of a linear strand of two or more nucleotides (deoxyribonucleotides and/or ribonulceotides) or variants, derivatives and/or analogs thereof. The exact size or length of nucleic acid employed depends upon the application and many other factors, as is known in the art. Nucleic acids may be derived from any natural source or may be modified. A DNA molecule is any DNA molecule of any size, from any source, including DNA from viral, prokaryotic and eukaryotic organisms, as well as synthetic DNA and variants, derivatives and analogs thereof. A RNA molecule is any RNA molecule of any size, from any source, including RNA from viral, prokaryotic and eukaryotic organisms, as well as synthetic RNA and variants, derivatives and analogs thereof. The RNA and DNA may be single stranded or double stranded, linear or circular, or supercoiled. Most references made to “biological macromolecules”, “desired macromolecules” or “target molecules or nucleic acids,” refer to molecules of polymeric nature, and may include DNA, RNA (for e.g., mRNA, tRNA, rRNA, etc.), derivatives of DNA and RNA, chimeric DNA/RNA molecules, enzyme digested nucleic acids fragments (for e.g., restriction enzymes, nucleases, etc.).

In accordance with the invention, “target nucleic acids,” also includes extrachromosomal DNA, e.g., plasmids and their fragments, vectors and their fragments, transposons, phagemids, cosmids, BACs, PACs, YACs, cDNA molecules, cDNA libraries, mitochondrial nucleic acid molecules, chloroplast nucleic acid molecules, genomic fragments, chromosomal DNA, etc. or combinations thereof. In particular, any vector and/or plasmid may be used, which may be either commercially available, or synthesized, or engineered, or derived thereof. Such vectors and/or plasmids may be used for cloning or subcloning nucleic acid molecules of interest and therefore recombinant vectors containing inserts, nucleic acid fragments or genes may also be isolated in accordance with the invention. General classes of vectors of particular interest include prokaryotic and/or eukaryotic cloning vectors, expression vectors, fusion vectors, two-hybrid or reverse two-hybrid vectors, shuttle vectors for use in different hosts, mutagenesis vectors, transcription vectors, vectors for receiving large inserts (yeast artificial chromosomes (YAC's), bacterial artificial chromosomes (BAC's) and P1 artificial chromosomes (PAC's)) and the like. Other vectors of interest include viral origin vectors (M13 vectors, bacterial phage λ vectors, baculovirus vectors, adenovirus vectors, and retrovirus vectors), high, low and adjustable copy number vectors, vectors which have compatible replicons for use in combination in a single host (e.g., pACYC184 and pBR322) and eukaryotic episomal replication vectors (e.g., pCDM8). The vectors contemplated by the invention include vectors containing inserted or additional nucleic acid fragments or sequences (e.g., recombinant vectors) as well as derivatives or variants of any of the vectors described herein. Expression vectors useful in accordance with the present invention include chromosomal-, episomal- and virus-derived vectors, e.g., vectors derived from bacterial plasmids or bacteriophages, and vectors derived from combinations thereof, such as cosmids and phagemids

Any cell, tissue, or organism may be used as the source of the biological macromolecules to be isolated, such that the macromolecules that are contained in the cell, tissue, or biological source (or portion thereof) are released from the cell, tissue, or organism. A cell may be prokaryotic, eukaryotic or viral, etc., and generally refers to any cell that contains a target nucleic acid of interest. The terms “host” or “host cell” may be used interchangeably herein. For examples of such hosts, see Maniatis et al., “Molecular Cloning: A Laboratory Manual,” Cold Spring Harbor Laboratory, Cold Spring Harbor, N.Y. (1982). Preferred prokaryotic hosts include, but are not limited to, bacteria of the genus Escherichia (e.g., E. coli), Bacillus, Staphylococcus, Agrobacter (e.g., A. tumefaciens), Streptomyces, Pseudomonas, Salmonella, Serratia, Caryophanon, etc. The most preferred prokaryotic host is E. coli. Bacterial hosts of particular interest in the present invention include E. coli strains K12, DH10B, DH5.alpha. and HB101. Preferred eukaryotic hosts include, but are not limited to, fungi, fish cells, yeast cells, plant cells and animal cells (particularly insect cells, and mammalian cells including human cells, CHO cells, VERO cells, Bowes melanoma cells, HepG2 cells, and the like). Cells may be transformed cells, established cell lines, cancer cells, or normal cells. Exemplary animal cells are insect cells such as Drosophila cells, Spodoptera Sf9, Sf21 cells and Trichoplusa High-Five cells; nematode cells such as C. elegans cells; and mammalian cells such as COS cells, CHO cells, VERO cells, 293 cells, PERC6 cells, BHK cells and human cells. Any virus may also be used as a cellular source of biological macromolecules, particularly nucleic acid molecules, in accordance with the invention. Also suitable for use as sources of biological macromolecules are mammalian tissues or organs such as those derived from brain, kidney, liver, pancreas, blood, bone marrow, muscle, nervous, skin, genitourinary, circulatory, lymphoid, gastrointestinal and connective tissue sources, as well as those derived from a mammalian (including human) embryo or fetus. These cells, tissues and organs may be normal, transformed, or established cell lines, or they may be pathological such as those involved in infectious diseases (caused by bacteria, fungi or yeast, viruses (including AIDS) or parasites), in genetic or biochemical pathologies (e.g., cystic fibrosis, hemophilia, Alzheimer's disease, schizophrenia, muscular dystrophy or multiple sclerosis), or in cancers and cancerous processes. Other cells, tissues, viruses, organs and organisms that will be familiar to one of ordinary skill in the art may also be used as sources of biological macromolecules for the preparation of biological macromolecules according to the present invention. In accordance with the invention, a host or host cell may serve as the cellular source for the desired macromolecule to be isolated.

As used herein, “cell disrupting” or “cell lysing” refers to a composition or a component of a composition that effects lysis, rupture, or poration of the cells, tissues, or organisms used as the source of the biological macromolecules to be isolated, such that the macromolecules that are contained in the cell, tissue, or biological source (or portion thereof) are released from the cell, tissue, or organism. According to the invention, the cells, tissues, or organisms need not be completely lysed, ruptured or porated, and all of the macromolecules of interest contained in the source cells, tissues or organisms need not be released therefrom. Preferably, a cell disrupting or cell lysis compound or composition comprises at least 25%, 50%, 75%, 80%, 85%, 90%, 95%, 97%, 99%, or more of the total biological macromolecules of interest, that are contained in the cell, tissue, or organism.

In accordance with the invention, the cells may be lysed or disrupted by contacting them with a composition or compound which causes or aids in cell lysis or disruption, although mechanical or physical forces (e.g., pressure, sonication, temperature (heating, freezing), and/or freeze-thawing etc.) may be used in accordance with the invention. In addition, any combination of mechanical forces, physical forces or lysis compositions/compounds maybe used to disrupt/lyse the cells, so long as the method does not substantially damage the biological macromolecules of interest.

In one aspect, the cell disrupting or cell lysing compound or composition may comprise one or more detergents, such as sodium dodecylsulfate (SDS), Sarkosyl, Triton X-100, Tween 20, NP-40, Nalkylglucosides, N-alkylmaltosides, glucamides, digitonin, deoxycholate, 3-[(3cholamidopropyl)-dimethylammonio]-1-propane-sulfonate (CHAPS), cetyltrimethyl-ammoniumbromide (CTAB), or Brij 35. The concentration may be about 0.01%-10% (w/v), more preferably about 0.1%-5%, and most preferably about 0.5%. One or more chaeotropic agents such as sodium iodide, sodium perchlorate, guanidine or a salt thereof or urea may be present at a concentration of about 300-1000 mM, more preferably about 500-2000 mM, and most preferably about 1500 mM. One or more enzymes may be present such as lysozyme, lyticase, zymolyase, neuraminidase, Novozym 234, streptolysin, cellulysin, mutanolysin or lysostaphin. Such enzymes may be present at a concentration of about 0.1 to 5 mg/ml. One or more inorganic salts may be present such as sodium chloride, potassium chloride, magnesium chloride, lithium chloride, or praseodymium chloride, at a concentration of about 1 mM to 5M. One or more organic solvents such as toluene, phenol, butanol, isopropyl alcohol, isoamyl alcohol, ethanol, an ether (e.g., diethyl ether, dimethyl ether, or ethylmethyl ether), or chloroform may be present at a concentration of 25 to 60% (v/v). Any other compound which disrupts the integrity of (i.e., lyses or causes the formation of pores in) the membrane and/or cell wall of the cellular source of biological macromolecules (e.g., polymixin B), may be present, or combinations of any of the foregoing. The compositions may also comprise other components, such as chelating agents (e.g., disodium ethylenediaminetetraacetic acid (Na EDTA), EGTA, CDTA), most preferably at a concentration of about 10 mM. One or more ribonucleases (RNase A, T1, T2, and the like) at concentrations ranging from 1 to 400 ug/ml, proteases (Protinase K, Pronase, pepsin, trypsin, papain, subtilisin) may be present at concentrations ranging from 50 to 1000 ug/ml, or any combination of the foregoing. Desired concentrations and combinations of the active ingredients of the lysis/disruption compositions may be readily determined by those skilled in the art with routine experimentation.

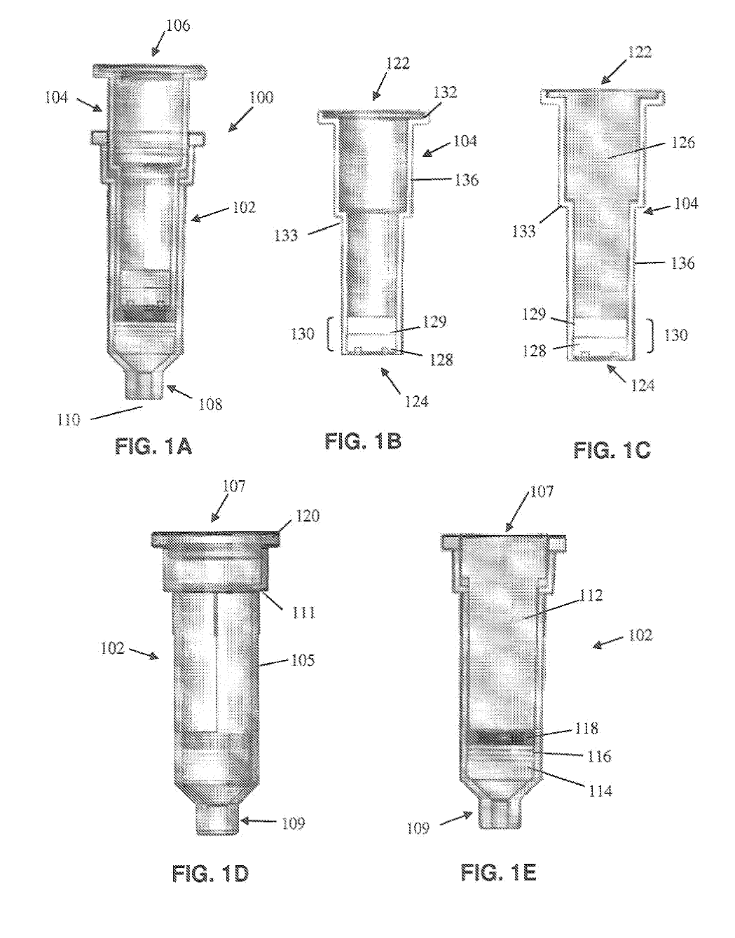

The term “clarification” as used herein refers to the process of removing unwanted cellular debris and/or large insoluble molecules from a cell lysate. Common methods of clarifying a cell lysate include centrifugation and filtration. In some embodiments, the unwanted debris is substantially retained in the filter in the clarification column (FIG. 1B) allowing the substantially clarified lysate to pass through the binding column containing the binding material (FIG. 1A).

The term “elution” as used herein refers to the process of extracting a molecule from a material by means of a solvent. The terms “eluting solution”, “elution buffer” and “elution solution” refer to the solvent used to extract a molecule from the material. The term “eluate” refers to the liquid solution resulting from an elution and containing the desired molecule.

The “eluate” may contain nucleic acid that may be considered “isolated”. As used herein, the term “isolated” (as in “isolated biological macromolecule”) means that the isolated material, component, or composition has been at least partially purified away from other materials, contaminants, and the like which are not part of the material, component, or composition that has been isolated. For example, an “isolated biological macromolecule” is a macromolecule that has been treated in such a way as to remove at least some of the other macromolecules and cellular components with which it may be associated in the cell, tissue, organ or organism. In particular, the phrases “isolated biological macromolecule,” “isolated nucleic acid molecule” or “isolated vector” refer to macromolecule preparations or vector preparations which contain about 10%, 20%, 30%, 40%, 50%, 55%, 60%, 65%, 70%, 75%, 80%, 85%, 90%, and 93%, preferably more than 95%, 97.5%, and 98%, and most preferably more than 99%, 99.5%, and 99.9% (percentages by weight) of the biological macromolecule of interest. As one of ordinary skill will appreciate, however, a solution comprising an isolated macromolecule may comprise one or more buffer salts and/or a solvents, e.g., water or an organic solvent such as acetone, ethanol, methanol, and the like, and yet the macromolecule may still be considered an “isolated” macromolecule with respect to its starting materials.

The nucleic acid molecules that are isolated by the compositions, methods and kits of the present invention may be further characterized or manipulated, for example by cloning, sequencing, amplification, labeling, nucleic acid synthesis, endonuclease digestion and the like, methods that are routinely used by one of ordinary skill in the art.

A vacuum seal, as used herein, can be formed between two device surfaces or between a device surface and the surface of an outlet of a vacuum manifold when a negative pressure/vacuum is applied to the device, for example through a vacuum manifold, as described herein. In some embodiments, the vacuum seal may be formed when the two surfaces engage on application of vacuum. The vacuum seal formed can be a partial vacuum seal. In some embodiments, the vacuum seal formed is sufficient to avoid undesired leakage of ambient atmosphere (e.g., air) through the seal at vacuum levels as employed to perform the filtering, washing and elution steps as described herein. The level of negative pressure/vacuum applied in device applications herein can be between 5 and 30 inches of Hg, such as between 5-10 inches of Hg, between 10-20 inches of Hg, between 15 and 20 inches of Hg, more than 20 inches of Hg. One or both surfaces which engage to form the vacuum seal can further comprise a sealing member, such as an o-ring, gaskets, washers, or other material that facilitates sealing. In addition, the seal can be facilitated by physical force such as latching mechanisms, locking mechanisms and the like, or the seal can be formed by virtue of application of the vacuum alone.

The term “nested” as used herein refers to two or more objects of similar or graduated size that can be stacked together or within each other, the smaller object or objects fitting within the object or objects of larger size.

### II. Devices

Provided herein are devices and methods suitable for clarifying or filtering a liquid mixture or sample, followed by binding of a desired molecule from the clarified or filtered liquid or sample to a binding material. The device and method can further comprise the subsequent elution of the desired molecule from the binding material. In some embodiments, the present invention provides a single device comprising a clarification/filtering column nested within a binding column, where the clarification column filters material from the liquid mixture and the binding column binds a desired target molecule or molecules from the filtered liquid. Also provided herein is a vacuum manifold apparatus having two or more vacuum chambers. The vacuum manifold apparatus can be adapted to receive and apply negative pressure to one or more devices. Negative pressure can be in the form of a vacuum or suction, or any other suitable force for drawing the sample through the device. Negative pressure can be applied using pumps or pre-evacuated containers. Alternatively, negative pressure can be applied using a centrifuge. In some embodiments, the vacuum manifold apparatus can be adapted to receive and apply negative pressure to multiwell plates (such as 96 well plates). In some embodiments, the device and methods are suitable for clarifying cell lysates followed by binding of a desired nucleic acid. The bound nucleic acid can then be eluted from the binding material if desired.

In some embodiments of the device, the clarification/binding device can be used for the clarification of a sample and the subsequent isolation of at least one target molecule from the sample. The sample can be a liquid sample or a dry sample that has been reconstituted/resuspended. For example, the device described herein can clarify a lysate sample and isolate a nucleic acid molecule from the clarified lysate. In some embodiments of the device, the device can be a dual column clarification/binding device comprising a two column design. In such an embodiment, an inner clarification or filtering column can be nested within an outer binding column. The dual column device provides for a dual layered stack of filtration materials through which the sample, for example lysate, can be clarified. The dual column device can also provide for a binding material for binding at least one target molecule. In some embodiments, more than one type of target molecule can be bound to the binding material. For example, the binding material can be designed so that the binding material can capture a nucleic acid and a protein. After the sample, for example, lysate, is filtered and the target molecule(s) captured by the binding material, the internal column (along with the unwanted debris) can, in some embodiments, be removed and discarded. The nucleic acid or other target molecule(s) bound to the binding material can then be optionally washed. In some embodiments where a nucleic acid and target molecule are both bound to the binding material, either the nucleic acid or other target molecule can be eluted from the binding material or both the nucleic acid and other target molecule can be eluted from the binding material. The nucleic acid can be eluted separately from the other target molecule. Alternatively, the nucleic acid and the target molecule can be eluted together.

In some embodiments of the device provided herein, the device can be a dual column device, wherein the dual column device comprises a hollow clarification column adaptable to be positioned within a hollow binding column. In some embodiments, the inner and binding columns are substantially cylindrical in shape. Alternatively, the inner and binding columns can be any suitable shape including, but not limited to, predominantly spherical, pyramidal, rectangular, irregular shapes and combinations thereof. The inner and binding column can be of the same geometry. Alternatively, the inner and binding column can be different geometries, provided the clarification column is able to be positioned within the binding column, and a vacuum seal formed between the inner and binding column. The inner and binding columns can be made of plastic, metal, composite material, glass, or any combination thereof, of any other suitable non-reactive or biocompatible material. In some embodiments, the inner and binding column can be fabricated using an injection moldable material that is able to withstand moderate vacuum pressure. The injection moldable material can also be able to withstand the force created by a centrifuge being used with the device. In some embodiments, the device can comprise a volume of in the range of between 500 uL and 1.5 mL. In some embodiments, the column can have a volume of approximately 750 uL. In some embodiments, the column can comprise a volume in the range of between 15 mL and 25 mL. In some embodiments, the column can have a volume of approximately 21 mL.

The device can further comprise a clarification column having an inlet/open end, an outlet, and an inner cavity able to receive a fluid. When assembled, the clarification column can be disposed within the internal bore of the binding column so that the inlet or open end of the clarification column is oriented in the same direction as the inlet or open end of the binding column, and the outlet of the clarification column is oriented in the same direction as the outlet of the binding column. The clarification column can extend all the way through the internal bore so that the outlet of the clarification column is adjacent to the binding material in the binding column. Alternatively, the clarification column can extend only partially through the internal bore so that there is a gap between the outlet of the clarification column and the binding material. In some embodiments, the inlet or open end of the clarification column can extend past the inlet or open end of the binding column and further comprises a tab or an annular ring that forms a lip over the open end of the binding column.

The internal bore of the binding column can be sized to accommodate the size of the clarification column so that a portion of the outer surface of the clarification column contacts a portion of the inner surface of the internal bore of the binding column and provides an interference fit between the clarification column and binding column. An interference fit can be a connection between two surfaces which can be achieved by friction after the surfaces are contacted together. An interference fit can be generally achieved by shaping the inner and binding columns so that one or the other (or both) slightly deviate in size from the nominal dimension. In some embodiment, the interference fit between the clarification column and binding column can be sufficiently airtight so that negative pressure applied to the outlet aperture will create a vacuum in the inner and binding columns. In general, when positioned into the binding column, the clarification column will be of such a dimension that the outer surface of the clarification column contacts and forms a vacuum seal with the inner surface of the binding column when negative pressure is applied. The fit between the outer and clarification column will not prevent the clarification column from being removed from the binding column when negative pressure is not applied.

The clarification column can further comprise an inner filter at or near the outlet of the clarification column. In some embodiments, the clarification column can comprise one or more filters. The inner filter can be any filter, separation column, plate, filtration matrix or filter material known in the art able to prevent large insoluble compounds from passing through the outlet of the clarification column. In some embodiments, the filter can be a paper like material. The selectivity of the inner filter, meaning the size of molecules able to pass through the inner filter, can be selected according to desired functionality of the device. In some embodiments, the inner filter can be a cell lysate clarification filter, disc, matrix, column or system able to prevent cellular debris and large insoluble molecules from passing through the inner filter. In some embodiments, the clarification column can further comprise a locking ring configured to prevent movement of the filter with respect to the clarification column.

In some embodiments, the filter can comprise at least two layers, a first layer and a second layer. The first layer and the second layer can be part of the same structure. Alternatively, the first layer and the second layer can be two separate structures. The filter can be an asymmetric filter. In such an embodiment, the pore size in the first layer of the filter is different from the pore size of the second layer of the filter. Alternatively, the first and second layers of the filter can have the same pore size. The device can comprise a first layer having a pore size in the range of between 5 um and 20 um and the second layer can have a pore size in the range of between 30 um and 100 um. In some embodiments, the first layer can have a pore size in the range of between 5 um and 7 um and the second layer can have a pore size in the range of between 40 um and 45 um. The filter can have any suitable pore size such that the unwanted molecules/debris are prevented from passing through the column and while not binding the target molecule, for example, DNA. In some embodiments, the filter can comprise more than two layers. In some embodiments, the filter can be a rigid structure, such as, for example, a two layer polyethylene frit. Alternatively, the filter can be a flexible membrane. In such an embodiment, the device can further comprise a support for the flexible membrane.

Further provided herein is a device comprising a binding column having an inlet and an outlet and an internal bore located between the inlet and outlet. The outlet of the binding column can terminate in an outlet aperture, wherein the inlet of the binding column and the outlet aperture are in communication, preferably fluid communication, through the internal bore. In some embodiments, the outlet of the binding column can be tapered so that the outlet aperture forms a narrow aperture or a luer nozzle.

The binding column can further comprise a binding material. The binding material can be any suitable material for capturing a target molecule including, but not limited to, fiber, matrix, resin, membrane, disc or filter, or any other suitable material or combination thereof. The binding material can capture at least one type of target molecule including, but not limited to, proteins or nucleic acids. In some embodiments, the binding material can be a DNA binding material such as silica and non-silica DNA binding material or a combination thereof. The DNA binding material can be any suitable chromatography material including, but not limited to, silica gel, aluminum oxide, titanium dioxide, porous glass, polymers, or any combination thereof. In some embodiments, the binding material can any suitable material for binding DNA such as a charge switch membrane, including glass fiber or nitrocellulose, or an anion exchange matrix, including derivatized glass fiber. In some embodiments, the binding material can be located within the internal bore of the binding column at or near the outlet. The binding material can be positioned at any suitable location so that the sample passing through the internal bore of the binding column and exiting through the outlet aperture must pass through the binding material.

In some embodiments the binding material can be a single layer of material. In some embodiments, the binding material can be multiple layers of material. The binding material can be at least two layers, at least three layers, or at least six layers. The layers of binding material can be in the range of between one and ten layers of material. The binding material can be any suitable number of layers depending on the amount of DNA desired. The binding material can comprise pores in the range of between approximately 1 um and approximately 5 um. In some embodiments, the pore size can be approximately 1 um. In some embodiments, the pore size can be approximately 0.7 um. The pore size can be any suitable size to allow for the binding of at least one target molecule. Additionally, the pores size can be of a suitable size to provide for adequate flow of the fluid or clarified sample through the device while providing high surface area to which the molecule can bind and thereby providing good yield of the at least one target molecule. For example purposes only, if an amount of DNA desired is approximately in the range of 5 ug to 30 ug of DNA, a mini dual column clarification/binding device with three layers of binding material can be used. If an amount of DNA desired is approximately in the range of between approximately 250 ug to 750 ug, a maxi column comprising six layers of binding material can be used. If an amount of DNA desired is approximately in the range of between 50 and 150 ug of DNA, a midi column comprising two layers of binding material can be used. These scenarios are for example purposes only, and those familiar in the art will be able to determine alternative scenarios using the device provided herein.

In some embodiments of the device provided herein, the binding column can comprise one or more support elements within the internal bore. The support element can maintain the position of the binding material within the internal bore. The support elements can be any structure that physically restricts movement of the binding material. Suitable support elements include, but are not limited to, support frits, locking rings, seals, ridges, inserts, tabs, or any combination thereof. The support elements can be separate pieces inserted into the binding column, such as a support frit inserted into the internal bore. Alternatively, the support element can be a modification of the surface of the internal bore, such as an annular ridge formed on the inner surface of the internal bore. The one or more support elements can be placed within the internal bore between the binding material and the outlet aperture, between the binding material and the inlet or open end of the binding column, or between the binding material and both the inlet or open end and outlet aperture. When multiple support elements are present, they may be the same type or different types of support elements. For example purposes only, in some embodiment a support frit can be placed in the internal bore between the binding material and the outlet aperture and a locking ring can be positioned between the binding material and the inlet or open end of the column.

The clarification column can be inserted into the binding column. In some embodiments, the clarification column can further comprise a depth stop located on the outer surface of the clarification column. The depth stop can function to limit the extent to which the clarification column can be inserted into the binding column. In some embodiments, the depth stop can be a continuous annular ring. In some embodiments, the depth stop can be a broken annular ring, one or more ribs, projections, surface modifications, or any other suitable mechanism for limiting the depth of insertion of the clarification column into the binding column. In some embodiments, the binding column can further comprise a depth stop located on the outer surface of the binding column. The depth stop on the binding column can limit the depth the binding column of the device can inserted into a vacuum manifold or a centrifuge tube. In some embodiments, the depth stop can be a continuous annular ring. In some embodiments, the depth stop can be a broken annular ring, one or more ribs, projections, surface modifications, or any other suitable mechanism for limiting the depth of insertion of the binding column.

Further provided herein is a vacuum manifold apparatus for use with one or more devices. In some embodiments, one or more devices of the present invention can be used in conjunction with a vacuum manifold. The vacuum manifold can have multiple vacuum chambers adaptable to introduce a vacuum simultaneously to each of the sample containing column devices during each of the filtering, binding, washing and elution steps used in isolating the target molecules. The apparatus can provide for rapid purification of nucleic acids, proteins, or other desired molecules from one or more samples. The vacuum manifold provided herein allows for all steps in a liquid mixture purification process, namely filtration, binding, washing and eluting steps, to be conducted using a single clarification/binding device and a vacuum manifold.

The vacuum manifold apparatus provided herein comprises a base having two or more vacuum chambers. In some embodiments, the vacuum manifold comprises a first vacuum chamber and a second vacuum chamber. A removable top plate can be used with each of the first and second vacuum chambers. A vacuum seal can be formed between the top plate and the vacuum chamber in use. A sealing member present on either the top plate or on the vacuum manifold can form at least a partial vacuum seal between the top plate and the vacuum manifold. The vacuum seal can be an airtight seal. Alternatively, the vacuum seal can be a partial vacuum seal wherein the vacuum chamber comprises a suitable level of negative pressure but is still at least partially open to the external environment. The sealing member can be an o-ring, gasket, latch, locking mechanism, or any other suitable sealing member for creating a seal. One or more openings in each of the top plates can be present for receiving a device. A vacuum seal can be formed between the top plate and the device to which a vacuum is to be applied. The vacuum seal can be facilitated by an outlet and vacuum supply connected to the first and/or second vacuum chambers. Application of negative pressure can be controlled by one or more valves. In some embodiments, the application of negative pressure can be controlled by a control unit. The control unit can be located directly on the vacuum manifold. Alternatively, the control unit can be located a suitable distance away from the vacuum manifold. When a suitable top plate holding one or more columns or a multiwell plate is placed over the open top of the vacuum chamber, a vacuum seal can be formed between the top plate and a vacuum manifold upon application of the pressure or as a result of using a latching device or locking mechanism in combination with the negative pressure. Connecting the vacuum chamber to a vacuum source can then generate a vacuum within the vacuum chamber.

The vacuum chambers can be connected to a negative pressure source through a valve, for example, a multiple-way tap. In some embodiments the vacuum chambers can be connected to a negative pressure source through a control unit. In some embodiments, the vacuum chambers can be connected to both a negative pressure source through a valve and a control unit. In some embodiments, the valve and/or control unit can connect or disconnect each vacuum chamber to and from the vacuum source. Each vacuum chamber can be controlled independently of the other. The negative pressure source can be any known in the art used to generate a vacuum, including but not limited to vacuums, such as oil pumps, diaphragm pumps, or pre-evacuated containers. In some embodiments, where a valve is used, a primary control valve can be used to open the desired vacuum chamber to the vacuum source. Alternatively, a control unit can use a primary control valve to connect the control unit to the vacuum source while two or more chamber valves open the desired vacuum chambers to the control unit. The two or more valves can be controlled independently of one another.

In some embodiments, the vacuum manifold comprises at least one of a fine control valve, a quick release valve, and a pressure gauge. In some embodiments, the fine control valve can controllably allow the passage of a small amount of air from the surrounding atmosphere into the vacuum manifold. In some embodiments, the fine control valve meters the level of vacuum. Allowing the passage of air from the atmosphere into the manifold apparatus can allow the operator to fine tune the strength of the negative pressure exerted in the vacuum chambers. In some embodiments, the quick release valve vents air into the manifold and releases the vacuum in the vacuum chambers rapidly. The pressure gauge can display the strength of the vacuum applied to the manifold. In some embodiments, the pressure gauge is an analogue display. In some embodiments, the pressure gauge is a digital display.

Each vacuum chamber can be adaptable to receive one or more removable top plates. The top plate can be a cover piece able to fit over the top of a vacuum chamber of the manifold apparatus. The top plate can be generally rectangular but can be any shape that allows the top plate to cover the open top of the vacuum chamber and form a vacuum seal with the manifold. The top of the manifold base may comprise a seal or gasket around each vacuum chamber to ensure an airtight seal is formed when a top plate is placed over the vacuum chamber. Optionally, the top plates can further comprise at least one locator stub that fits within at least one corresponding locator hole located along the top of the manifold base. The interaction between the at least one locator stub and the at least one locator hole can guide proper placement of the top plate over the vacuum chamber. The top plate can be used with any of the vacuum chambers. For example purposes only, the top plate can be used with a vacuum manifold comprising a first and second vacuum chamber. In some embodiments, the top plate can be used with the first vacuum chamber first and then used with the second vacuum chamber. In some embodiments, the top plate can be large enough to be used with both the first and second chambers simultaneously.

In some embodiments, the top plate can be configured for use with at least one mini column device. In some embodiments, the top plate can be configured for use with a midi/maxi column device. In some embodiments, the top plate can be configured for use with both a mini and a midi/maxi column device. In some embodiments, the top plate can be configured for use with a multiwell plate, for example, a 96-well multiwell plate. In some embodiments, the top plate can be used with a combination of the mini columns, the midi/maxi columns and the multiwell plate. In some embodiments, the top plate can be used with a stop plate. The stop plate can be used with a midi/maxi column top plate. The stop plate can be used to limit the depth that the midi/maxi columns are inserted into the vacuum chamber. In some embodiments, the top plate can be used with a vacuum collar. The vacuum collar can be used, for example, with a multiwell plate. The vacuum collar can be positioned around the entire multiwell plate to create a vacuum within each of the wells of the multiwell plate without having to form a seal around each individual well.

In some embodiments, each top plate comprises one or more openings. The one of more openings can allow the devices to be inserted through the top plate so that when the top plate is placed over the vacuum chamber, the bottoms of the columns extend into the vacuum chamber. The number and size of the openings in the top plate can be selected depending on the number and size of the columns to be inserted into the top plate. Alternatively, stopper or any other suitable closing mechanism can be placed in or over an opening not containing a device. In some embodiments, each opening in the top plate can further comprise a retaining element. The retaining element can be any suitable structure that provides a friction surface against an object inserted into the opening. The retaining element additionally can ensure that an airtight seal is formed between the top plate and the barrel of a column inserted within the top plate. In some embodiments, the retaining element is a rubber or plastic retaining ring positioned within the opening. In some embodiments, the retaining ring can be positioned above the opening. In some embodiments, the retaining ring can be positioned below the opening. The retaining ring can be integrated with the top plate. Alternatively, the retaining ring can be a separate structure.

In some embodiments, the top plate can comprise an opening adaptable to accommodate a multiwell adapter plate (such as a 96 well clarification plate). Alternatively, the top plate contains one or more luer lock connectors allowing columns with luer nozzles to be connected to the plate.

A sample added to a device, such as a dual column device or multiwell plate, inserted into a top plate located on the vacuum manifold can be pulled through the dual column device or multiwell plate by the negative pressure. As the sample is manipulated through the device and the target molecule(s) bound, the unbound portion of the clarified sample can then exit from the device. A waste tray located in the bottom of the vacuum chamber can then collect the unbound portion of the clarified sample. The unbound portion of the clarified sample can then be discarded. In an embodiment where a multiwell plate is used, the sample can be passed through a clarification multiwell plate into a binding multiwell plate. In some embodiments, the binding material in the binding column can be washed at least once. The washes can also be collected in the waste tray. A collection tray or rack can be placed in the bottom of the vacuum chamber to collect the liquid. The desired portion of the sample can be eluted from the device. A collection rack having a plurality of collection tubes can be placed in the vacuum chamber and the desired sample collected. The collection rack can comprise a collection tube positioned beneath each column inserted in the top plate. To reduce the chance of contamination of the collected liquid, preferably the outlet aperture of each column extends into open space beneath the top plate and does not physically contact the top plate or collection tube. The columns can extend far enough into the vacuum chamber so that the outlet aperture is located within the bore of the collection tube. Furthermore, the columns can extend far enough so that all of the liquid from each column can be collected by the designated collection tube. In some embodiments, where either the unbound portion of sample or the used wash buffers are desired, the unbound portion of sample and the used wash buffers can be collected into collection tubes.

In some embodiments, one or more devices of the present invention can be inserted in a top plate. The top plate can be positioned over a first vacuum chamber so that a vacuum seal is formed between the top plate and the manifold base when a vacuum is applied. A sample, for example, cell lysate can be added into the clarification column and negative pressure applied to the first vacuum chamber. The negative pressure can manipulate the sample through the inner filter and out of the clarification column into the binding column. Cellular debris and large insoluble molecules can be filtered out of the sample by the inner filter. The negative pressure can further move the clarified or filtered sample through the binding material where the desired target molecules can be captured. The sample can then travel out of the binding column through the outlet of the binding column and into a waste tray placed in the bottom of the vacuum chamber. In some embodiments, the clarification column can be removed. The vacuum can be released and the clarification column removed. In some embodiments, after the clarification column is removed, the binding material can be washed at least once.

Once the sample has been filtered or clarified, the target molecule bound, and if desired, washed after the clarification column has been removed, the vacuum can be removed and the vacuum chamber vented by operating the quick release valve. The one or more devices are not removed from the top plate, but instead the top plate is removed from the first vacuum chamber and placed over a second vacuum chamber containing an elution tray and a plurality of collection tubes. Alternatively, the top plate can be removed from the first vacuum chamber, and the waste tray removed. The waste tray in the first vacuum chamber can then be replaced by an elution tray with the appropriate number of collection tubes. The top plate with the columns can then be placed back over the first vacuum chamber. In such an embodiment, only one vacuum chamber is used for both the clarifying/binding/washing and elution. Alternatively, the top plate can be removed from the first vacuum chamber containing the waste tray and placed over the second vacuum chamber containing an elution tray. The elution tray can hold at least one collection tubes for collecting the eluted target molecule. In such an embodiment, the first vacuum chamber is used for the clarifying/binding/washing and the second vacuum chamber is used for the elution.

In some embodiments, where the target molecule is to be eluted from the devices, an elution buffer can be used to elute the bound target molecules from the binding material in the binding column of the devices. Negative pressure can then be applied to the vacuum chamber containing the elution tray and collection tubes. The negative pressure can move the eluting solution through the binding material in the binding column. The eluting solution causes the desired molecules to be released into the eluting solution. The eluting solution can then be collected by the collection tubes in the elution tray. Multiple aliquots of eluting solution or elution buffer can be added as needed to release all of the desired target molecules from the binding material.

Referring to FIGS. 1A-1E, the dual column clarification/binding device 100 described herein can, in some embodiments, comprise a clarification column 104 nested within a binding column 102. FIG. 1A illustrates a side view of an embodiment of a device 100 having an input 106 located at the proximal end, or end furthest from an apparatus when placed in communication with an apparatus, and an output 108 located at the distal end, or end closest to the apparatus. In some embodiments, the input 106 can be located at one end of the device 100. In some embodiments, the input 106 can be located at any suitable location along the length of the column. Additionally, in some embodiments the column can comprise one output 108. In some embodiments the device can comprise more than one output 108. The more than one output can be located at one end of the device. Alternatively, in some embodiments where the input is located along the length of the column, the one or more than one outputs can be located at the same end or at opposite ends of the device. The output end 108 of the binding column 102 can further comprise an outlet aperture 110. The outlet aperture 110 can be an open aperture as shown in FIG. 1A. In some embodiments, the outlet aperture can be a luer nozzle. A column comprising a luer nozzle can facilitate the insertion of a column with a luer nozzle into or onto a luer lock, or a luer lock valve.

As seen in FIG. 1A, the device can be a dual column device comprising an clarification 104 and binding 102 column. The clarification column can be sized to allow a close fit of the clarification column within the binding column. When vacuum is applied to outlet aperture 110, a vacuum seal can be formed between the nested clarification and binding columns. In some embodiments, binding column 102 and internal bore 112 can be sized so that the outer surface 136 of the clarification column 104 contacts the inner surface 134 of the internal bore 112 to provide thereby creating an interference fit between the inner and binding columns. The interference fit can be sufficient to form a vacuum seal. In some embodiments, the vacuum seal between the two columns is facilitated by engagement of the lip 132 on the clarification column 104 and the lip 120 on the binding column 102 when negative pressure is applied to the dual column device 100.

FIG. 1B is a side view of an embodiment of an clarification column 104 of a dual column device. FIG. 1C is a cross-sectional view of the clarification column shown in FIG. 1B. FIGS. 1B and 1C show an clarification column 104 having an inlet 122 and outlet 124. The inlet 122 and the outlet 124 are in communication, preferably fluid communication, through an internal cavity 126. In some embodiments, a filter 130 can be located at or in close proximity to the outlet 124 of the clarification column 104. The filter 130 can be a rigid structure, such as a frit. The filter 130, matrix, membrane, particulates, resin, or any other suitable material for filtering the sample, can be positioned at or near the outlet 124 of the clarification column 104. The filter 130 can be selected to remove undesired solids from the sample prior to the passage of sample from the clarification column into the binding column. In some embodiments, filter 130 can be a clarification matrix. A sample, for example, a fluid sample, can be introduced into the inlet 122 of the clarification column 104. The fluid can then pass through inner cavity 126 and subsequently pass through the filter 130 before exiting the clarification column 104 from the outlet 124.

In some embodiments, the filter 130 can be a single structure comprising more than one layer. In some embodiments the filter 130 can be a two layer filter having a first layer 128 and a second layer 129, as shown in FIGS. 1B and 1C. The filter 130 can filter unwanted debris. The filter can be comprised of paper or polyethylene or any other suitable material. In some embodiment, the filter can be a flexible structure, such as a membrane. In such an embodiment, a support structure can support the membrane. The filter comprise pore having uniform pore size. Alternatively, the filter can have pores that vary in size throughout the filter. In some embodiments, the filter is an asymmetric filter wherein the first layer comprises pores of one uniform size and the second layer comprises pores of a second uniform size. In some embodiments, the first layer can have pores of varying sizes and the second layer can have pores of varying sizes. In some embodiments, the filter can be more than two layers. For example purposes only, in some embodiments, the filter 130 used can be a two layer filter with a top layer 129 and a bottom layer 128. The top layer 129 of the filter 130 can have a pore size of between 15 um and 45 um while the bottom layer 128 can have a pore size of between 7 um and 15 um. The pore size of the filter or any parts of the filter can be in the range of between approximately 5 um and approximately 50 um.

In some embodiments, the clarification column 104 can have a radially extending top lip 132 at the inlet 122 of the clarification column 104, as shown in FIGS. 1B and 1C. Lip 132 can extend radially either partially or fully around the top circumference of the clarification column 104. The lip can facilitate gripping and handling of the clarification column 104. In some embodiments, the lip 132 can engage the top circumference of binding column 102. Alternatively, the lip 132 can engage the lip 120 of the binding column 102. In some embodiments, the lip 132 can be used as a depth stop to restrict the distance the clarification column 104 can be inserted into the binding column 102. The outer surface 136 of the clarification column 104 can further comprise a feature or depth stop 133 for restricting the depth that the clarification column 104 can be inserted into the binding column 102. The depth stop 133 can be a ridge, ring, surface modification, appendage, or any other feature that can restrict the depth of insertion of the clarification column into the binding column.

FIG. 1C shows a side view of one embodiment of a binding column. FIG. 1D illustrates a cross-sectional view of the binding column shown in FIG. 1C. As shown in FIG. 1C, the binding column comprises an inlet 107 and an outlet 109. The inlet 107 is in communication, preferably fluid communication, with the outlet 109 through an internal bore 112 as shown in FIG. 1D. A sample introduced to the column through the inlet 107 passes through the bore 112 and out through the outlet 109. At or near the outlet 109 of the binding column 102, the bore 112 comprises a binding material 116. In some embodiments the binding column can further comprise one or more support elements 116, e. g., frit, for supporting the binding material. As illustrated in FIG. 1B, in some embodiments, the binding material 114 can be placed between a support 114 and a locking ring 118. The locking ring 118 can hold the binding material 116 in place within the binding column 102. The locking ring 118 can be a separate element inserted into the binding column 102 after the binding material is added to the binding column 102. Alternatively, the locking ring 118 can be integrally formed with the inner surface of the internal bore 112, for example, a structure that deforms under pressure to allow the binding material to pass by but which returns to its original configuration after the binding material has passed. The support 114 and the binding material 116 can be inserted near or at the outlet 108 of the binding column 102 below the locking ring 118.

In some embodiments of the binding column 102, the binding column comprises a top lip 120 projecting radially from the inlet 106 of the binding column 102 as shown in FIGS. 1D and 1E. Lip 120 can extend radially either partially or fully around the top circumference or edge of the binding column 102. In some embodiments, the outer surface 105 of the binding column 102 can further comprise a feature or depth stop 111. The depth stop 111 on the binding column 102 can be used to restrict the depth that the binding column 102 can be inserted into a vacuum manifold. Alternatively, the depth stop 111 can be used to limit the depth that the outer tube can be inserted into any suitable container, such as a centrifuge tube. The depth stop 111 can be a ridge, ring, surface modification, appendage, or any other feature that can restrict the depth of insertion of the clarification column into the binding column.

In some embodiments, a sample, for example purposes only, lysate or other liquid, can be introduced into the internal cavity 126 of the clarification column 104 of the device 100 shown in FIG. 1A. Negative pressure can then be applied to the device to cause the sample in the inner cavity 126 to move through the inner filter 126 into the internal bore 112 of the binding column 102. As the sample passes through the inner filter 126, insoluble materials can be filtered from the sample. The filtered or clarified sample, for example, filtered or clarified lysate, can then be pulled through the binding material 116n the binding column 102 and out through the outlet aperture 110. As the filtered or clarified sample or lysate passes through binding material 116, at least one target molecule present in the sample can be captured by the binding material 116. In some embodiments, one kind of target molecule can be captured by the binding material. In some embodiments, the binding material can be such that more than one kind of target molecule can be captured by the binding material.

In order to manipulate the sample through the device, a negative pressure source can be applied to the device through the outlet 108 of the device 100. At least one of the clarification, binding, washing, and elution steps can be performed under the negative pressure. In some embodiments, the negative pressure source can be a vacuum source connected externally to the dual clarification/binding column. In some embodiments, the vacuum source can be a vacuum pump. The vacuum source can be any suitable vacuum source including, but not limited to, vacuum pumps, vacuum manifolds, oil pumps, diaphragm pumps, liquid ring pumps, dry pumps, positive displacement pumps, pre-evacuated containers, or any other suitable vacuum source for creating at least a partial vacuum within the device. In some embodiments, the force for moving the fluid can be created using a centrifuge. The centripetal force created by the centrifuge can cause the sample to move through the device. The centrifuge can be a high-speed centrifuge, a desktop centrifuge, microcentrifuge, cooling centrifuge, ultracentrifuge, or any other suitable centrifuge. In some embodiments, the force for moving the sample through the device can be controlled automatically. Alternatively, the force can be created manually, such as by using a manually controlled pump. In some embodiments, the device can be used with a single source of force such as using one vacuum pump. Alternatively, the device can be used with at least two sources of negative pressure, such as two vacuum pumps.

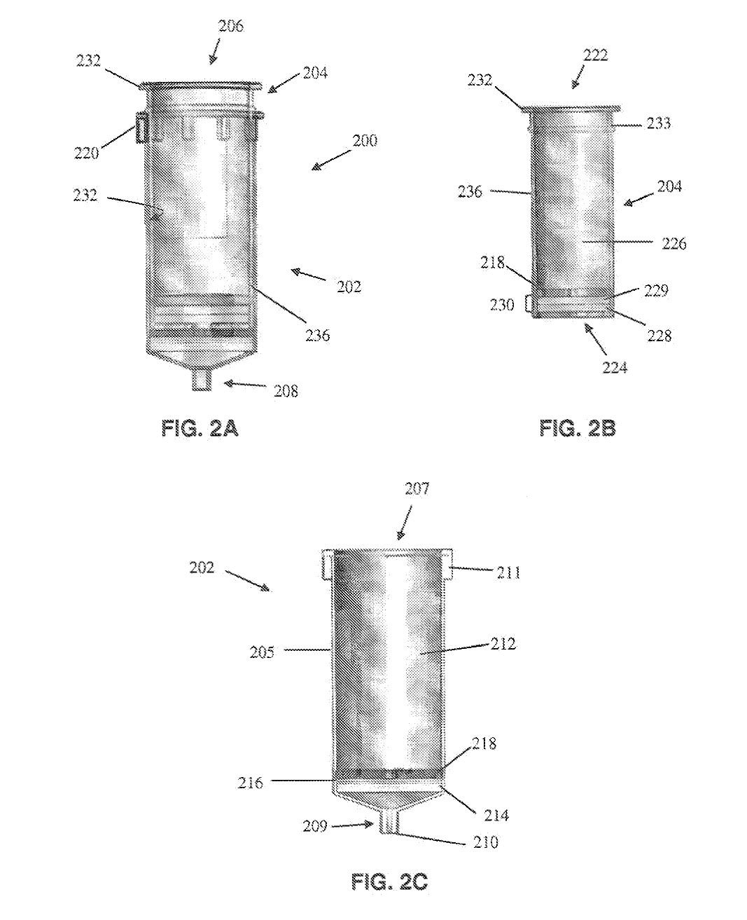

In some embodiments, the dual column clarification/binding device can be a midi/maxi dual column clarification/binding device. One embodiment of a midi/maxi dual column clarification/binding device is shown in FIGS. 2A-2C. FIG. 2A illustrates device 200 comprising an clarification column 204 being nested within a binding column 202. In some embodiments, the external wall 236 of the clarification column 204 can fit tightly with inner wall 234 of the binding column 202. This tight interference fit between the inner and binding column can create, in some embodiments, at least a partial vacuum seal. In some embodiments, a lip 220 on the binding column 202 can interact with a lip 232 on the clarification column 204 to create at least a partial vacuum seal between the clarification column 204 and the binding column 202.

FIG. 2B illustrates an clarification column 204 of a midi/maxi dual column device. The clarification column 204 can comprise a inlet 222 and an outlet 224. The outlet 224 can be in communication, preferably fluid communication, with the inlet 222 through an internal bore 226. A filter 230 can be located at the distal end of the clarification column 204. The filter 230 can be supported a single layer filter. Alternatively the filter 230 can have a first layer 228 and a second layer 229, as shown in FIG. 2B. In some embodiments, the filter can have more than two layers. The filter 230 can filter unwanted debris. The filter can be comprised of paper or polyethylene or any other suitable material. In some embodiment, the filter can be a flexible structure, such as a membrane. In such an embodiment, a support structure can support the membrane. The filter comprise pore having uniform pore size. Alternatively, the filter can have pores that vary in size throughout the filter. In some embodiments, the filter is asymmetric filter wherein the first layer comprises pores of one uniform size and the second layer comprises pores of a second uniform size. In some embodiments, the first layer can have pores of varying sizes and the second layer can have pores of varying sizes. In some embodiments, the filter can be more than two layers. In some embodiments, the clarification column 204 can further comprise a locking ring 218 for holding the filter 230 in position within the clarification column.

In some embodiments, the clarification column 204 can have a radially extending top lip 232 at the inlet 222 of the clarification column 204. Lip 232 can extend radially either partially or fully around the top circumference of the clarification column 204. The lip can facilitates gripping and handling of the clarification column 204. In some embodiments, the lip 232 can engage the top circumference of binding column 202. Alternatively, the lip 232 can engage the lip 220 of the binding column 202. In some embodiments, the lip 232 can be used as a depth stop to restrict the distance the clarification column 204 can be inserted into the binding column 202. In some embodiments, the outer surface 236 of the clarification column 204 can further comprise a feature or depth stop 233 for restricting the depth that the clarification column 204 can be inserted into the binding column 202. The depth stop 233 can be a ridge, ring, surface modification, appendage, or any other feature that can restrict the depth of insertion of the clarification column into the binding column.

FIG. 2C illustrates the binding column 204 of a midi/maxi dual column device 200. The binding column has an inlet 207 located at the proximal end and an outlet 209 located at the distal end. The outlet 209 has an aperture 210 from which a sample can be extracted from the tube. The outlet 209 is in communication, preferably fluid communication, with the inlet 207 of the binding column 202. The internal bore 212 of the binding column 202 enables passage of the sample from the inlet 207 to the outlet 209. At or near the distal end of the binding column 202, a binding material 216 can be present. The binding material can be any suitable material for binding DNA. Additionally the binding material can be suitable for eluting DNA. The binding material can be a matrix, membrane, resin, treated beads or particulates, glass fibers or any other suitable material for binding and/or eluting DNA. In some embodiments, the binding material can have a pore size of approximately 1 um. In some embodiments, the pore size of the binding material can be approximately 0.5 um. In some embodiments, the binding material can have a pore size of greater than 0.5 um, greater than 1.0 um, greater than 2 um, greater than 5 um, or any other suitable size pore.

In some embodiments, there can be a single layer of binding material. In some embodiments, there can be more than one binding material layer. In some embodiments, the binding material can have at least two layers, at least 3 layers, at least 6 layers. In some embodiments, the binding material can be comprised of between 1 to 10 layers of binding material, or any other suitable amount of binding material layers. The binding material layers can in some embodiments capture a single type of target molecule, for example, DNA. In an alternate embodiment, the binding material can capture more than one type of target molecule, for example purposes only, DNA and a protein of interest. The binding material can capture the target molecule or molecules of interest in a single layer. Alternatively, the target molecules can be separated into different layers as captured by different layers of binding material. In some embodiments, the binding material can be supported by a support 214, for example, a frit, as discussed above. In some embodiments, the support 214 can be any suitable support material as previously disclosed. In some embodiments, the binding column can further comprise a locking ring 218.

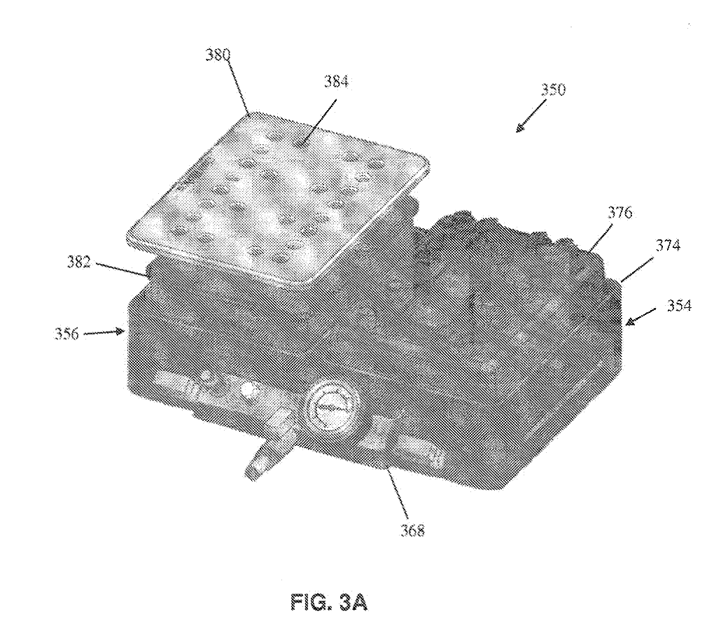

Further provided herein is a vacuum manifold apparatus for use with the dual column clarification/binding device described herein. FIG. 3A illustrates a perspective view of an embodiment of a vacuum chamber manifold. As shown in FIG. 3A, the vacuum chamber manifold can comprise at least two chambers. A first chamber 356 can be used to facilitate at least one of clarifying, purifying, binding, and washing of the sample. A second chamber 354 can be used to facilitate the elution and/or collection of a target molecule. A top plate 380 can be used with the first vacuum chamber 356 or the top plate can be used with the second vacuum chamber 354. In some embodiments, the top plate can be used with both of the vacuum chambers 356,354. An embodiment of a top plate 380 is shown in FIG. 3A. The top plate 380 can be positioned over the first vacuum chamber 356 and can form a seal with the chamber when under vacuum. In some embodiments, the seal can be formed using other mechanisms for sealing the top plate and the vacuum chamber together including, locking or latching mechanisms. The top plate 380 can comprise one or more openings 384 for receiving one or more dual column devices. Additionally, the top plate can form a vacuum seal around each of the inserted tubes or devices. The top plate can further comprise a sealing ring to form a seal between the top plate and the devices. During elution, the top plate holding the collection tubes can be placed over the second chamber. The second chamber 354 can have an elution tray 374. The elution tray 374 can hold at least one collection tube. The devices can be in communication with the collection tubes through the holes 376 in the elution tray 374.

FIG. 3B illustrates a top view of an embodiment of a vacuum manifold 350. As shown, the vacuum manifold 350 can be a dual chamber vacuum manifold. The vacuum manifold can be used to provide a plurality of forces for manipulating the sample. For example purposes only, the vacuum manifold can simultaneously apply a vacuum to one or multiple dual column collection/elution and/or elution devices described herein. In some embodiments, the vacuum manifolds can have at least two independent vacuum chambers 354 and 356, as shown in FIG. 3B. Though described herein as a first chamber and a second chamber, either chamber can be configured to clarify, bind, wash, and/or elute. For ease of reference only, they are referred to herein as a first and second chamber and the uses are described with reference to a first or second chamber. The first chamber 354 can be used for at least one of either filtering, clarification, binding and/or washing steps. The second chamber 356 can perform at least one of elution and/or collection steps. In some embodiments, more than two chambers can be present in the vacuum manifold. The vacuum manifolds, for example, can facilitate easy transfer of multiple filtering, collection or eluting devices from a first vacuum chamber to a second vacuum chamber. In some embodiments, the top plate 380 holding the at least one dual column device can be moved and placed over the second chamber 354. In some embodiments, more than one column can be inserted into the top plate. Vacuum can then be applied to all columns simultaneously.

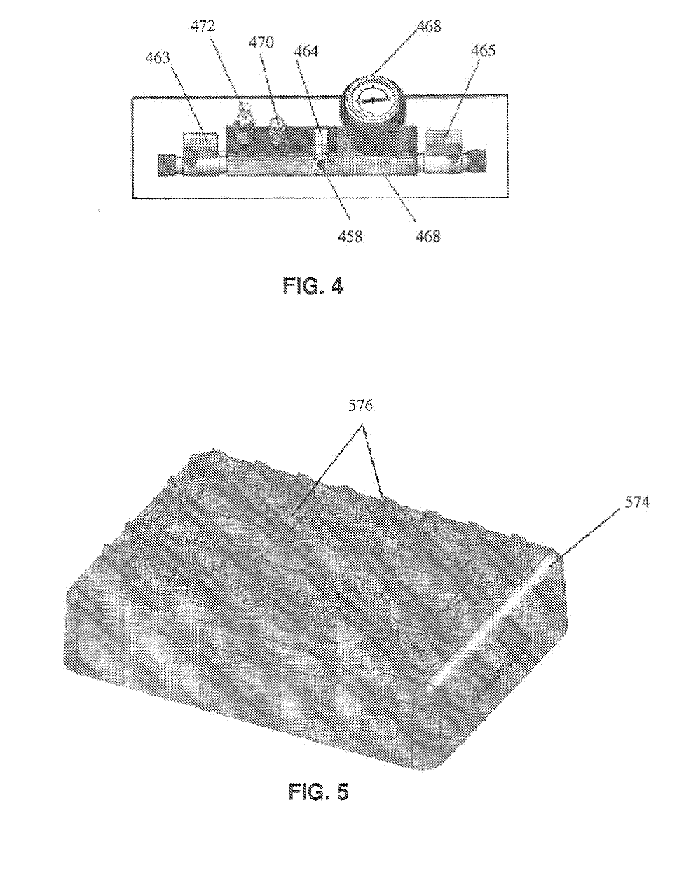

As shown in FIG. 3B, in some embodiments, the first and second chambers, 354, 356 of the vacuum manifold 350 can include one or more locator holes 362 around their periphery. The locator holes can be used with a top plate (shown in FIGS. 6-8) that can be used to facilitate the holding of the dual column devices (discussed herein). The locator holes 362 can receive corresponding locator stubs located on a top plate. In some embodiments, the apparatus can further comprise a sealing member. In some embodiments, the sealing member can be located on the vacuum manifold. The sealing member 353, 355 can surround the first chamber 354 and the second chamber 356, respectively. In some embodiments, the sealing member can surround both the first chamber and the second chamber. In some embodiments, the sealing member can be located on the top plate. The sealing member can ensure that at least a partial vacuum seal can be formed when the top plate is placed over either the first chamber 354 or the second chamber 356.

In FIG. 3B, the vacuum manifold 350 comprises two independent vacuum chambers 354, 356 respectively, which can be connected to a vacuum source (not shown). The vacuum manifold 350 and the chambers can be connected to a vacuum source through a control unit 368. The control unit 368 can comprise a vacuum supply connector 358 such as vacuum compatible tubing, or any other suitable supply connector known in the art. The vacuum supply connector 358 facilitates communication between the negative pressure source and the dual chambers 354, 356 of the vacuum manifold 350. The vacuum supply can control whether negative pressure can be applied through the chambers 354,356. The vacuum supply 358 can, in some embodiments, further comprise a valve 364, as shown in FIG. 3B. The valve 364 can be, for example, a three-way tap. The valve 364 can be adjusted to supply negative pressure to either the binding/washing chamber 354 or the elution chamber 356. Turning the valve 364 to the appropriate position can connect or disconnect one of the dual vacuum chambers 352 from the vacuum source. Negative pressure can be supplied to either the first vacuum chamber 354 or the second vacuum chamber 356. Alternatively, valve 364 can be positioned such that both chambers are provided with vacuum at the same time. In some embodiments, the control unit can further comprise a pressure gauge. In some embodiments, the control unit can further comprise a quick release valve. In some embodiments, the control unit can further comprise a fine control valve.

An alternate embodiment of a vacuum manifold is shown in FIG. 3C. In such an embodiment, the vacuum manifold 350 can be controlled by a control unit 368. The control unit 368 can facilitate the connection and disconnection of each of the dual chambers 354, 356 from the negative pressure source. In such an embodiment, more than one valve 363, 364, 365 can be used to control supply of vacuum to the chambers 354, 356 and to the manifold 350. A primary valve 364 can be use to control whether negative pressure is supplied to the dual chambers 354,356 of the vacuum manifold 350. Additionally, application of negative pressure to the first chamber 354 can be controlled by a first chamber valve 363. Application of negative pressure to the second chamber 356 can be controlled by a second chamber valve 365. Opening the primary valve 364 can supply a vacuum to the control unit 368. Further opening and closing the first and second valves 363, 365, respectively, can connect or disconnect the negative pressure source to the first and second chambers 354, 356, respectively. In such an embodiment, negative pressure can be applied to either one of the vacuum chambers or to both vacuum chambers simultaneously. The control unit can further comprise a pressure gauge 366. The pressure gauge can display the level of negative pressure being delivered. In some embodiments, the negative pressure being delivered is between 15 to 20 inches of Hg. In some embodiments, the level of negative pressure/vacuum applied can be between 5-10 inches of Hg, between 10-20 inches of Hg, between 15 and 20 inches of Hg, or more than 20 inches of Hg. In some embodiments, the pressure can be between 0 to 30 inches of Hg. Additionally, in some embodiments, the control unit 368 can further comprise a quick release valve 370. In some embodiments, the quick release valve 370 can be used to release the vacuum created in the first and second chambers. The quick release valve 370 releases the negative pressure by drawing air into the dual chambers 352. In some embodiments, a fine control valve 372 can be present on the control unit 368 to provide for fine control of the vacuum. The fine control valve 372 can be used modify the level of negative pressure being supplied to the chambers 352.

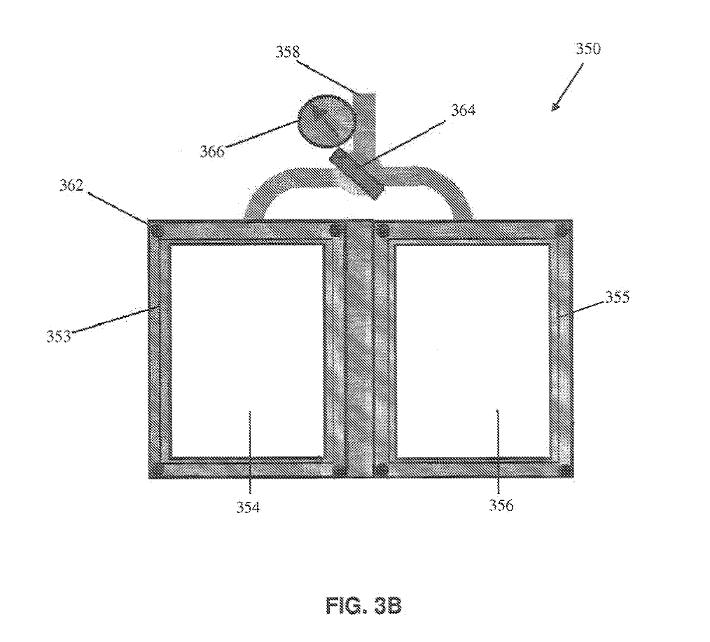

FIG. 4 illustrates an embodiment of a control unit 468 isolated from the vacuum manifold. In some embodiments, the control unit further includes a pressure gauge 466, a fine control valve 472, and a quick release valve 470. The control unit 468 can control the negative pressure delivered to the dual chambers of the vacuum manifold through the primary valve 464 and the first chamber valve 463 and the second chamber valve 465.

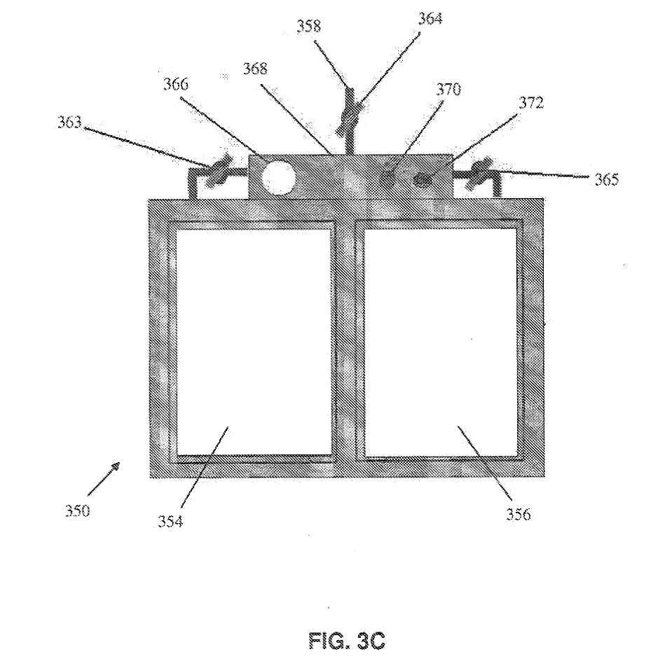

In some embodiments, one of the chambers of the vacuum manifold can serve as an elution chamber for collecting the desired target molecule. In some embodiments, the elution chamber can further comprise an elution tray 574 as shown in FIG. 5. The elution tray 574 can have at least one tube holder 576. In some embodiments the elution tray 574 can have a plurality of tube holders 576, as shown in FIG. 5. Each tube holder can support a collection tube. The elution tray 574 can be configured in any suitable orientation. Additionally, the elution tray 574 can be configured to interact with any suitable amount of dual column devices. The elution tray 574 can be configured to interact with either a mini dual column device or with a midi/maxi dual column device. The elution tray can be configured such that the same tray can be used with both mini dual column devices and midi/maxi dual column devices. In use, any suitable number of collection tube holders 576 can be provided in the elution tray, with each holder 576 configured to receive a collection tube into which the bound nucleic acid or other target molecule can be eluted. Accordingly, there should be at least as many holders 576 as dual column devices that are in the top plate during elution. In some embodiments, of the top plate, there may be fewer dual column devices than the number of collection tube holders 576 in which case some of the collection tube holders 576 can be left empty.

The dual column clarification/binding devices can be used with a top plate for receiving and holding one or more of the devices. An embodiment of a top plate 680 is shown in FIG. 6. The top plate 680 can comprise at least one opening 684 for receiving at least one dual column device. The top plate can comprise the number of openings corresponding to the number and size of the dual columns to be used with the vacuum manifold. For example purposes only, if 24 dual column devices were to be used with the vacuum manifold, the top plate can be designed to have only 24 openings. Alternatively, if 16 dual column devices were to be used, a plate having more than 16 openings can be used, with openings not receiving a dual column device being filled with a stopper, for closing the unused hole. The top plate 680 can be designed with openings for any suitable number of dual column devices, the only limiting factor being available space and, when used for elution, the number of collection tubes that can be placed in the collection tube holder.

In some embodiments, the top plate can further comprise a retaining ring. In some embodiments, the retaining ring can restrict the downward movement of the column when the column is positioned into an opening in the top plate. The retaining ring can have a diameter less than the size of the opening. As the column is inserted through the opening, the retaining ring can press against the outer surface of the column. In some embodiments, the retaining ring can serve to hold the column in place. In some embodiments, the interaction between the column and the retaining ring can facilitate the formation of a seal when negative pressure is applied. In some embodiments, the retaining ring can be located within the opening. Alternatively, the retaining ring can be located above or below the opening. In some embodiments, the retaining ring can be integrated with the opening as a single unit. In some embodiments, the tube can be positioned in the opening and then a retaining ring positioned around the column. One retaining ring can be used with top plate. In some embodiments, more than one retaining ring can be used with the top plate. In some embodiments, the retaining ring can be a circular piece of rubber. In some embodiments, the retaining ring can be a circular piece of plastic. The retaining ring can be an o-ring or gasket.

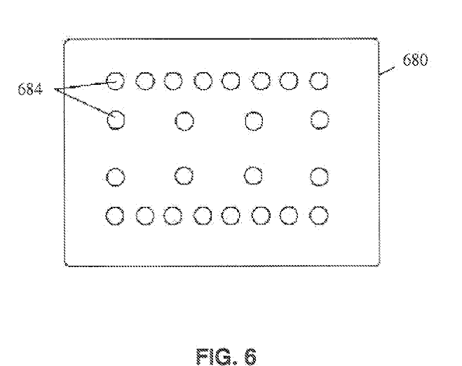

An alternate embodiment of a top plate is shown in FIG. 7A. The top plate 780 can be configured with larger openings 784 to accommodate midi/maxi dual column devices. FIG. 7B is a cross-sectional view of the top plate 780 shown in FIG. 7A along the line B-B. In some embodiments, the top plate can further comprise a retaining ring 786. In some embodiments, the retaining ring can restrict the downward movement of the midi/maxi column when the column is positioned into an opening 784. The ling ring can have a diameter less than the size of the opening. As the column is inserted through the opening, the retaining ring can press against the outer surface of the column. In some embodiments, the retaining ring can serve to hold the column in place. In some embodiments, the interaction between the column and the retaining ring can facilitate the formation of a seal when negative pressure is applied. In some embodiments, the retaining ring can be located within the opening. Alternatively, the retaining ring can be located above or below the opening. In some embodiments, the retaining ring can be integrated with the opening as a single unit. In some embodiments, the tube can be positioned in the opening and then a retaining ring positioned around the column. In some embodiments, each opening 784 of the top plate 780 has one retaining ring 786, as shown in FIG. 7B. In some embodiments, each opening has more than one retaining ring. In some embodiments, the retaining ring 786 can be a circular piece of rubber. In some embodiments, the retaining ring can be a circular piece of plastic. The retaining ring can be an o-ring or gasket.

In some embodiments, the top plate can further comprise at least one locator stub 763, as shown in FIG. 7B. The at least one locator stub 763 can be inserted into a locator hole (for example, 362 in FIG. 3A) that can be present surrounding each chamber of the vacuum manifold chamber. The insertion of the locator stub 763 into the locator hole can serve to align the top plate 780 with the vacuum chamber. Alternatively, the top plate can be aligned with respect to the manifold using rubber strips. The rubber strips on the manifold can interact with an indentation on the top plate. The top plate can be aligned with the vacuum chamber using any suitable structure including grooves, clamps, or any other suitable structure for aligning the top plate with the vacuum chamber. In some embodiments, the stop plate can further comprise at least one finger hole 785.

In some embodiments, a stop plate can be used with the vacuum chamber manifold. An embodiment of a stop plate 788 is shown in FIG. 7C. The stop plate can have openings corresponding to the openings in the top plate. For example, the eight openings 784 in the top plate 780 shown in FIG. 7A are aligned with the eight small openings 784 in the stop plate 788 as shown in FIG. 7C. The openings in the stop plate can be located below each of the openings in the top plate so that at least a portion of the column inserted into the top plate contacts the opening in the stop plate. The stop plate thereby can limit the depth the column can be inserted into the vacuum chamber. In some embodiments, the stop plate can be integrally formed with the top plate. In such an embodiment, the stop plate can be separated from the top plate using predefined spacers. Alternatively, the top plate and the stop plate can be separate elements. The stop plate can be positioned between the vacuum chamber and the top plate. The stop plate can then limit the depth to which the columns interact with the vacuum chamber and the columns from falling into the waste or into the collection containers. The stop plate openings 784 can be smaller than the top plate openings. The reduction in size of the openings in the stop plate as compared to the top plate can facilitate the insertion of a column into top plate opening, while preventing the column from being inserted further through the top plate. The stop plate can further comprise finger holes 785 as shown in FIG. 7B. The finger holes 785 can facilitate the insertion and/or removal of the stop plate with respect to the vacuum chamber. In some embodiments, the stop plate can rest directly on the edges of the waste tray. In some embodiments, the stop plate rests on a lip located in the waste tray. The stop plate can in some embodiments be used during the clarifying, binding, and/or washing steps. The stop plate can thereby prevent the columns from coming in contact with the discarded waste in the waste tray. In some embodiments, the stop plate can be used to prevent the columns from coming in contact with the collection tubes. In some embodiments, a stop plate between the columns and the collection tubes may not be used.

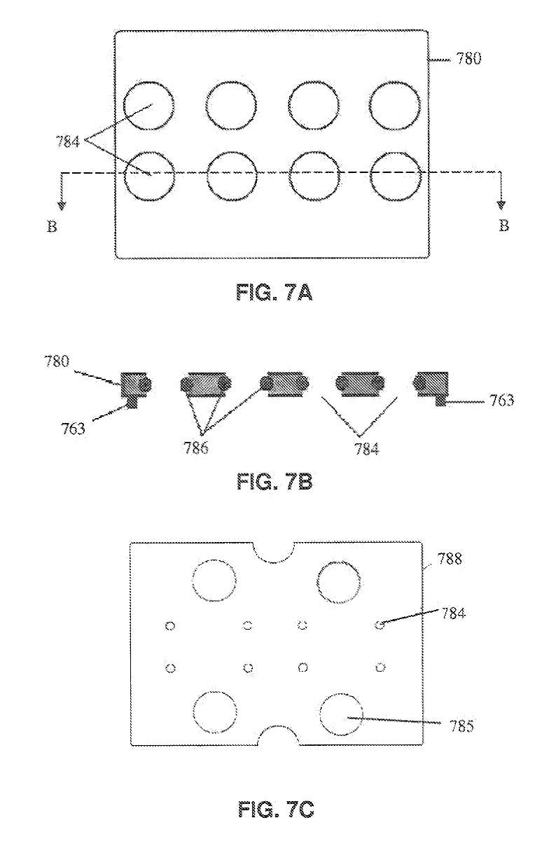

Another alternate embodiment of a top plate is shown in FIG. 8A. FIG. 8 illustrates a top plate 880 having luer connectors 890 for receiving columns having luer nozzles. A luer lock or luer valve 892 that can be connected to the luer connectors 890 is shown in FIG. 8B. The luer lock or luer valve 892 can facilitate whether negative pressure is applied to individual devices connected to the luer connector/luer lock. In one position the luer lock or valve can prevent negative pressure from being applied to a column in communication with the luer lock or valve. When the luer lock is in the closed open position, negative pressure can be introduced inside the column. A luer lock or valve can be used with a column to individually control the application of negative pressure to the column. In some embodiments, a luer lock or valve can be used with a column during at least one of the clarification, binding, and/or washing of the target molecule. In some embodiments, the elution of the target molecule can occur with the luer lock or valve in place. In some embodiment, the elution of the target molecule can occur after the luer lock or valve has been removed from the column. The removal of the luer lock or valve can facilitate elution of the target molecule from the binding material without additional contamination from additional structure.

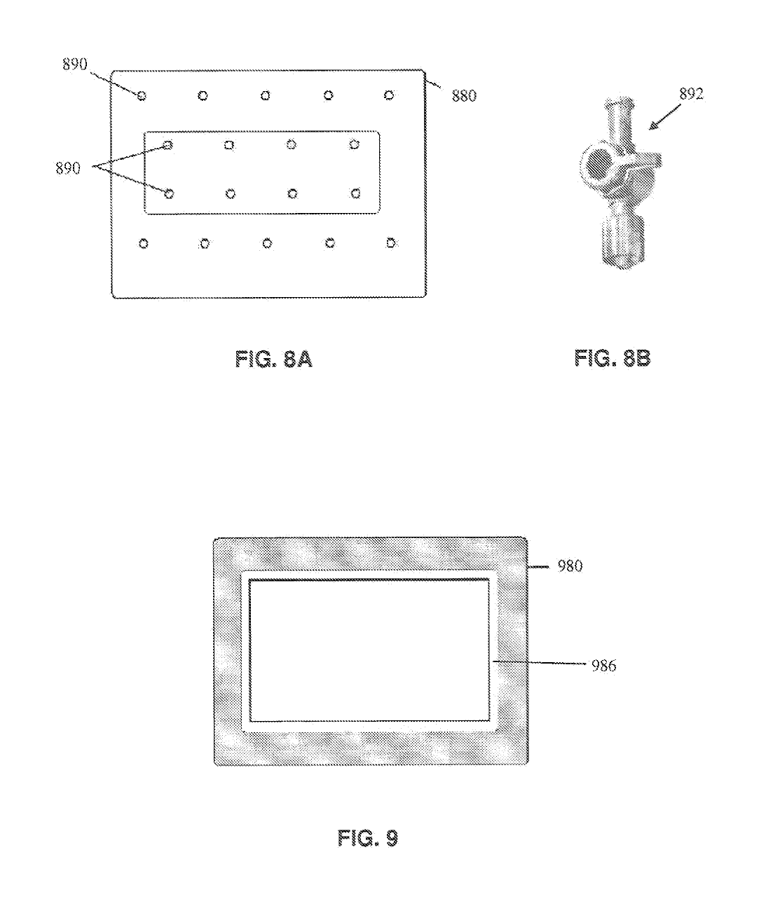

Yet another embodiment of a top plate is shown in FIG. 9. FIG. 9 illustrates a top plate 980 for receiving a multiwell plate. The multiwell top plate can further comprise a sealing member 986 to facilitate forming a seal with a multiwell plate. The sealing member can be positioned around the circumference of the multiwell plate. Because individual wells are joined together, in some embodiments, air does not pass through the spaced between the individual wells. The top plate 980 and sealing member 986 can then be positioned around the multiwell plate. When under vacuum, the sealing member 986 forms at least a partial vacuum seal around the multiwell plate thereby introducing negative pressure to each individual well.

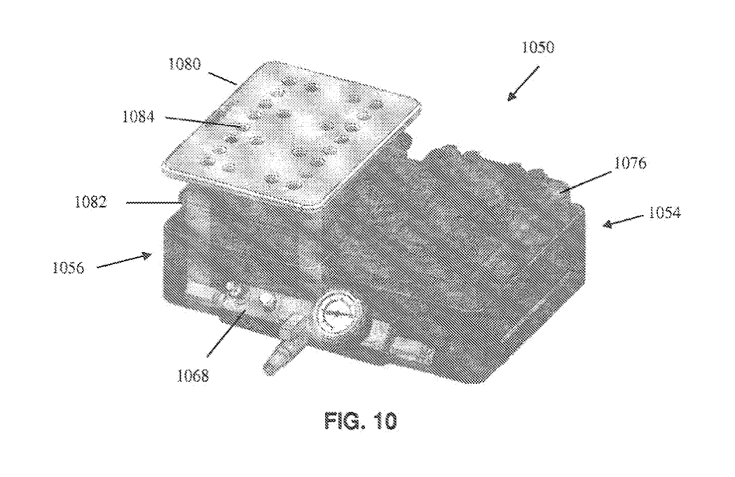

An exploded view of the elements of an embodiment of a vacuum manifold apparatus 1050 with control unit 1068 is shown in FIG. 10. The apparatus 1050 further comprises a top plate 1080 for receiving at least one mini dual column device. The apparatus 1050 can comprise a clarifying/binding chamber 1052 and an elution chamber 1054. The clarifying/binding chamber 1052 can have a washing tray 1082. The elution chamber 1054 can comprise an elution tray 1076, which can be the same or different than the elution tray shown in FIG. 10.

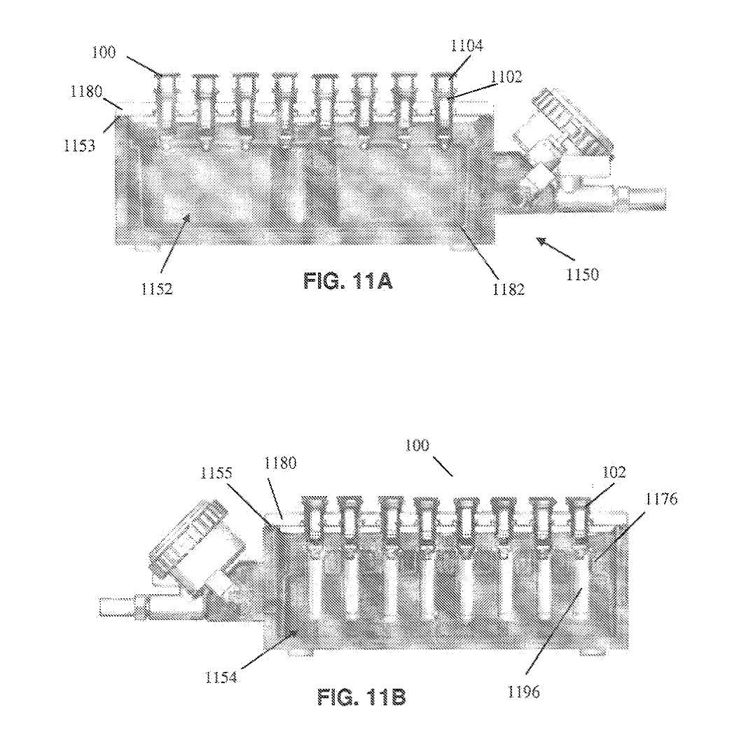

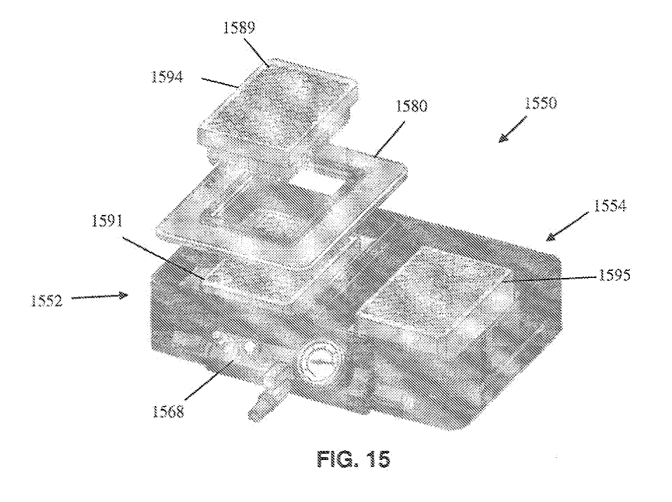

FIGS. 11A and 11B illustrates cross-sectional views of a vacuum manifold for use with mini dual clarification/binding columns. FIG. 11A illustrates a cross-sectional view of the clarifying/binding/washing chamber 1152 of the apparatus with mini dual column devices 100 placed within the top plate 1080 of the apparatus. In FIG. 11A, the devices 100 are configured to empty into a waste tray 1182. FIG. 15B illustrates a cross-sectional view of the elution chamber 1154 with mini dual column devices 100. An elution tray 1176 is located within the elution chamber 1154. In some embodiments, the elution tray can hold at least one collection tube 1196. In some embodiments, the elution tray can hold one collection tube for each dual column device being used. In FIG. 11B, the devices are shown in communication, preferably fluid communication, with the series of collection tubes 1196 for collecting the eluted sample.

Referring to both FIG. 10 and FIGS. 11A and 11B, for example purposes only, an embodiment of the device and vacuum manifold can be used in the following manner. Cells in media are spun and the supernatant is removed. A suitable amount of RNase can then be added to a resuspension buffer (unless the resuspension buffer already includes a suitable amount of RNase) which may then be added to the pellet to resuspend the cells. A lysis buffer may then be added to the sample for no more than 5 minutes. The sample is then neutralized with addition of a neutralization buffer. The sample may then be introduced into a device or devices 100. The devices 100 are then inserted into a top plate 1080. In some embodiments, the top plate 1080 is already positioned on a vacuum chamber 1056 of a vacuum manifold 1050, while in other embodiments, the devices 100 are inserted into the top plate 1080 and then the top plate 1080 is placed over a vacuum chamber 1056 of a vacuum manifold 1050. A waste tray 1082 can be positioned in the vacuum chamber 1056 over which the top plate 1080 is to be placed.

FIG. 11A illustrates the devices positioned in the vacuum manifold 1150. The control unit 1068 can then be used to activate the vacuum manifold 1050. A sealing member 1153 can facilitate the formation of at least a partial vacuum seal between the vacuum chamber 1152 and the top plate 1180. The vacuum created in the chamber 1152 can then create a reduction in pressure in the device 100 in the space between the clarification column 104 and the binding column 102, thereby sealing the clarification column 104 and the binding column 102 together. The vacuum may then be used to draw the sample through the filter of the clarification column 104 of the device thereby clarifying the sample. The vacuum then causes the clarified sample to pass into the binding column 102 of the device 100, through the binding material, where the target molecule or molecules is bound and then out of the device 100 into the waste tray 1182. Under vacuum, the sample is clarified by the clarification column 104 of the device 100 and bound to a binding material in the binding column 102. The unwanted portion of the sample is then collected in the waste tray 1182. In some embodiments, the vacuum can be released and the clarification column 104 removed from the device 100. At least one wash buffer can be introduced to the binding column 102 and vacuum reapplied to draw the wash buffer through the binding column 102 and into the waste tray 1182. The vacuum can be released and the top plate removed from the vacuum chamber 1152.

Once the vacuum has been released and the top plate lifted from the vacuum chamber 1152, the top plate 1180 can then be positioned over an elution tray 1176. The elution tray 1176 can be positioned in the first vacuum chamber from which the waste tray 1182 has been removed or, alternatively, the elution tray can be positioned in a second vacuum chamber 1154, as shown in FIG. 11B. The elution tray 1176 can comprise at least one collection tube 1196. In some embodiments, the elution tray 1176 can comprise at least one collection tube 1196 for each device in the top plate 1180. An elution buffer may then be added to the binding columns 102. A sealing member 1155 can facilitate the formation of at least a partial vacuum seal between the vacuum chamber 1154 and the top plate 1180 upon application of a vacuum to the chamber and the vacuum created can then cause the elution buffer to pass through the binding material in the binding column 102 thereby eluting at least one target molecule into a collection tube 1196. Multiple aliquots of elution buffer can be added to the binding column as desired. The vacuum can then be released, the top plate 1180 removed from the vacuum chamber 1154, the collection tubes 1196 sealed and then removed from the elution tray 1176.

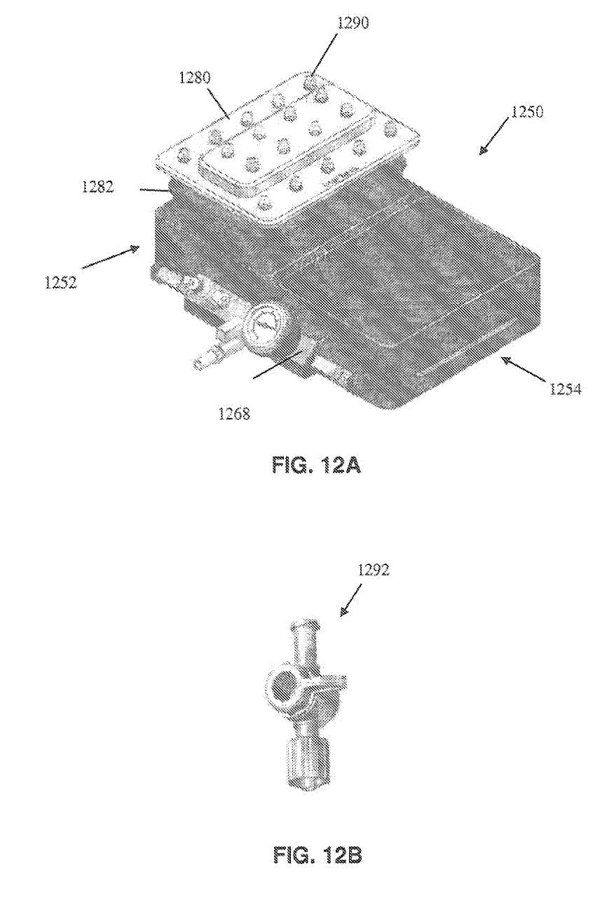

FIG. 12 illustrates a vacuum manifold apparatus 1250 with control unit 1268 for use with a column having a luer nozzle. The apparatus 1250 further comprises a top plate 1280 for receiving at least one dual column device comprising a luer nozzle. A luer connector 1292 can for connecting the column to the top plate 1280 is shown in FIG. 12B. The apparatus 1250 can comprise a washing/binding chamber 1252 and an elution chamber 1254. The washing/binding chamber 1252 can have a waste tray 1282. The elution chamber 1254 can comprise an elution tray. FIG. 12 shows the elution chamber without an elution tray.

The embodiment shown in FIG. 12 works with mini dual column tubes as previously described but having the additional option of controlling each column individually. The luer lock of the individual devices to be used can be positioned so that the valve is in the open position. The remainder of the lock or valves can be in the closed position. Vacuum is therefore not applied to those devices which are in the closed position whereas vacuum is applied to those devices whose corresponding locks or valves are in the open position.

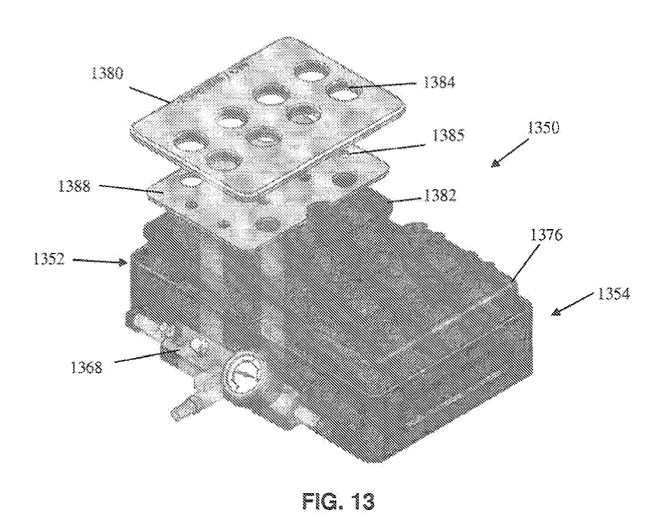

FIG. 13 illustrates a vacuum manifold apparatus 1350 with control unit 1368. The apparatus 1350 can further comprise a top plate 1380 for receiving at least one midi/maxi dual column device. The apparatus 1350 can further comprise a stop plate 1388 for control of the depth that the columns are inserted into the apparatus. The openings 1384 of the top plate 1380 are aligned with the openings 1385 of the stop plate 1388. The apparatus 1350 can comprise a washing/binding chamber 1352 and an elution chamber 1354. The washing/binding chamber 1352 can have a washing tray 1382. The elution chamber 1354 can further comprise an elution tray 1376, which can be the same or different than the elution tray shown in FIG. 13.

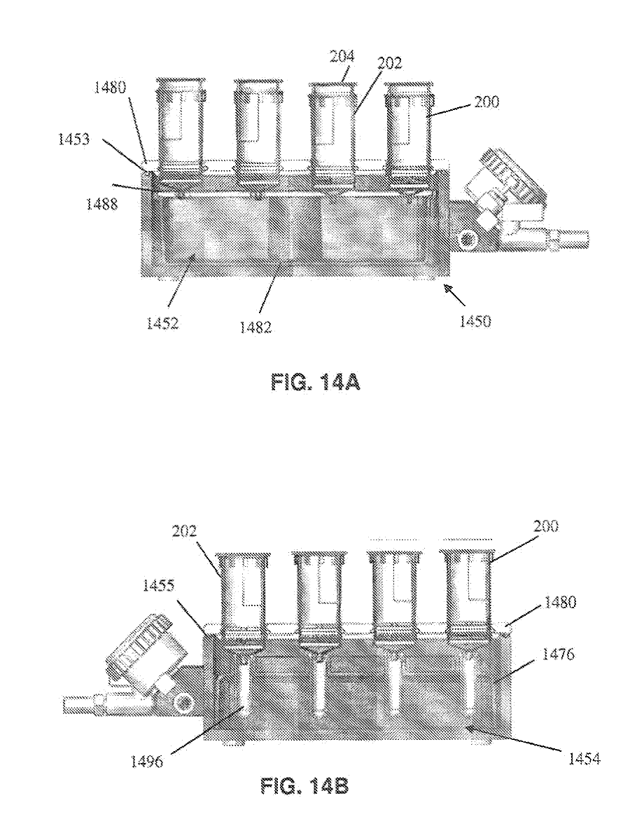

FIGS. 14A and 14B illustrates cross-sectional views of a vacuum manifold for use with midi/maxi dual clarification/binding columns. FIG. 14A illustrates a cross-sectional view of the clarifying/binding/washing chamber 1452 of the apparatus with midi/maxi dual column devices 100. In FIG. 14A, the devices 200 are emptying into a waste tray 1482. The devices are prevented from contacting the contents of the waste tray 1482 by a stop plate 1488. FIG. 14B illustrates a cross-sectional view of the elution chamber 1454 with midi/maxi dual column devices 200. An elution tray 1476 is located within the elution chamber 1454. In some embodiments, the elution tray can hold at least one collection tube 1496. In some embodiments, the elution tray can hold one collection tube for each dual column device being used. In FIG. 14B, the devices are shown in communication, preferably fluid communication, with the series of collection tubes 1496 for collecting the eluted sample. In some embodiments, a stop plate can be used during elution. In some embodiment, a stop plate is not used during elution. In such an embodiment, the column 200 can rest directly on the tops of the collection tubes 1496, as shown in FIG. 14B.

Referring to both FIG. 13 and FIGS. 14A and 14B, for example purposes only, an embodiment of the device and vacuum manifold can be used in the following manner. Cells in media are spun and the supernatant is removed. A suitable amount of RNase can then be added to a resuspension buffer (unless the resuspension buffer already includes a suitable amount of RNase) which may then be added to the pellet to resuspend the cells. A lysis buffer may then be added to the sample for no more than 5 minutes. The sample is then neutralized with addition of a neutralization buffer. The sample may then be introduced into a device or devices 200 or devices. Prior to preparing the devices for use, a waste tray 1382 can be positioned in a vacuum chamber 1352 of a vacuum chamber manifold 1350. A stop plate 1388 can then be positioned on the waste tray 1382. The devices 200 are then inserted into a top plate 1480. In some embodiments, the top plate 1480 is already positioned on a vacuum chamber 1452 of a vacuum manifold 1450. In some embodiments, the devices 200 are inserted into the top plate 1480 and then the top plate 1480 is placed over a vacuum chamber 1452 of a vacuum manifold 1450. The stop plate 1488 positioned on the waste tray 1482 limits the depth the devices 200 in relation to the waste tray 1482.

FIG. 14A illustrates the devices positioned in the vacuum manifold 1450. The control unit 1368 can then be used to activate the vacuum manifold 1450. A sealing member 1453 can facilitate the formation of at least a partial vacuum seal between the vacuum chamber 1452 and the top plate 1480. The vacuum created in the chamber 1452 can then create a reduction in pressure in the device 200 in the space between the clarification column 204 and the binding column 202 thereby sealing the clarification column 204 and the binding column 202 together. The vacuum may then be used to draw the sample through the filter of the clarification column 204 of the device thereby clarifying the sample. The vacuum then causes the clarified sample to pass into the binding column 202 of the device 200, through the binding material, where the target molecule or molecules is bound and then out of the device 200 into the waste tray 1482. Under vacuum, the sample is clarified by the clarification column 204 of the device 200 and bound to a binding material in the binding column 202. The unwanted portion of the sample is then collected in the waste tray 1482. In some embodiments, the vacuum can be released and the clarification column 204 removed from the device 200. At least one wash buffer can be introduced to the binding column 202 and vacuum reapplied to draw the wash buffer through the binding column 2102 and into the waste tray 1482. The vacuum may then be released and the top plate 1480 removed from the vacuum chamber 1452.

Once the vacuum has been released and the top plate lifted from the vacuum chamber 1452, the top plate 1480 can then be positioned over an elution tray 1476. The elution tray 1476 can be positioned in the first vacuum chamber from which the waste tray 1482 has been removed or, alternatively, the elution tray can be positioned in a second vacuum chamber 1454, as shown in FIG. 14B. The elution tray 1476 can comprise at least one collection tube 1496. In some embodiments, the elution tray 1476 can comprise at least one collection tube 1496 for each device in the top plate 1480. An elution buffer may then be added to the binding columns 202. A sealing member 1455 can facilitate the formation of at least a partial vacuum seal between the vacuum chamber 1454 and the top plate 1480 upon application of a vacuum to the chamber and the vacuum created can then cause the elution buffer to pass through the binding material in the binding column 102 thereby eluting at least one target molecule into a collection tube 1496. Multiple aliquots of elution buffer can be added to the binding column as desired. The vacuum can then be released, the top plate 1480 removed from the vacuum chamber 1454, the collection tubes 1496 sealed and then removed from the elution tray 1476.

FIG. 15 illustrates a vacuum manifold apparatus 1550 with control unit 1568 for use with a multiwell plate. Multiwell plates (such as 96 well plates) suitable for use on a vacuum manifold can be used to filter a sample in all or some of the wells. In some embodiments, multiple multiwell plates can be used, where each multiwell plate performs a different step of the clarification/binding process. In such an embodiment, the sample can be introduced into a clarification multiwell plate 1594. A multiwell binding plate 1591 can be placed in the vacuum chamber to receive the clarified sample from the clarifying multiwell plate, as shown in FIG. 15. The clarified sample is passed from the clarifying plate to the binding plate under vacuum. The binding plate can comprise a binding material for binding at least one target molecule. The multiwell top plate 1580 (as shown in FIG. 15) can be used to hold the multiwell clarification and/or binding plate to ensure the multiwell plates are held in place and properly aligned. A sealing member 1581 located on the top plate 1580 can form at least a partial seal between the multiwell clarifying plate 1594 or the multiwell binding plate 1591 and the top plate. Additionally, one or more supports can be placed in the bottom of the vacuum chamber to raise the multiwell collection plate and/or binding plate to the proper height so that the liquid is properly collected in the appropriate wells. The multiwell binding plate 1591 can then be removed from the bottom of t he vacuum chamber and inserted into the top plate. In some embodiments, the binding plate can then be washed. The waste from the binding plate can then empty directly into a washing tray. The binding multiwell plate can then be positioned over a multiwell collection plate 1595 to collect the eluted target molecule from the binding plate 1591.

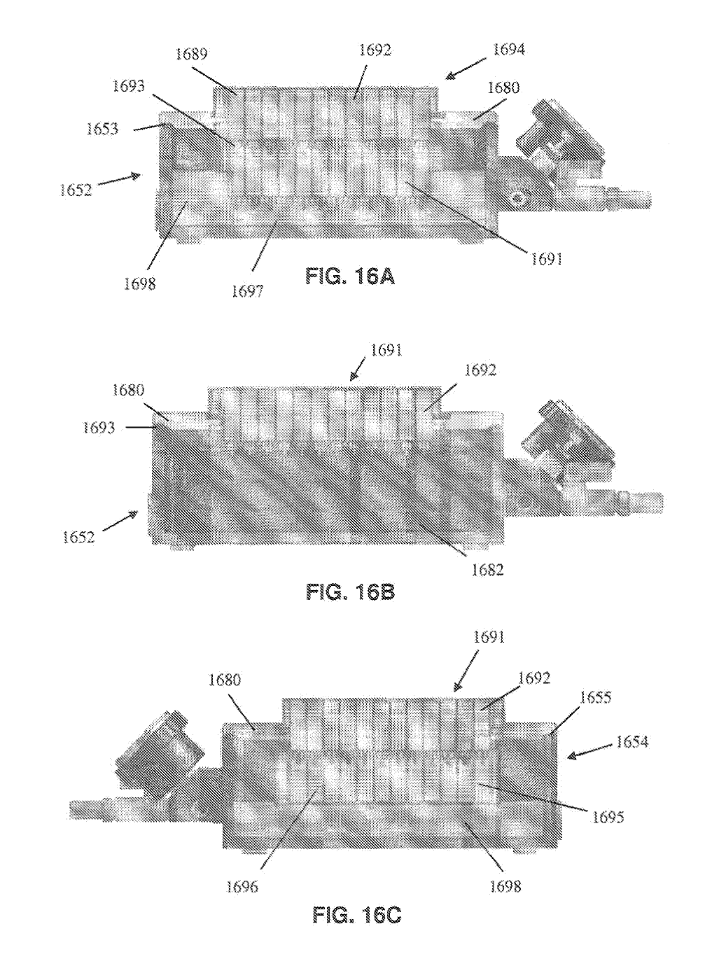

FIGS. 16A-16C illustrate a vacuum manifold being used with a multiwell plate. The multiwell plate can have nozzles 1693 on the bottom of the individual wells to direct the liquid into the wells of the receiving plate 1691. In some embodiments, at least one sample is placed in at least one well 1689 of a clarifying plate 1694. The clarified sample(s) can then be collected in a binding plate 1691 located in the vacuum chamber, as shown in FIG. 16A. The binding plate 1691 can contain a binding material able to bind at least on target molecule(s) from the clarified sample. The receiving plate height, with respect to the washing/binding chamber 1654, can be adjusted using at least one support 1698, as shown in FIG. 16A. The sample can pass through the binding material into the waste container 1697 located under the binding plate 1691. The binding plate 1691 can then be removed from the vacuum chamber. The binding plate 1691 can be washed at least once and the washes captured in a waste tray 1682, as shown in FIG. 16B. The binding plate 1691 can be removed from the first vacuum chamber and positioned over the second vacuum/elution chamber. The sample can then be eluted from the binding plate 1691 and the eluted target molecule can be collected in the wells of the collecting plate 1695, as shown in FIG. 16C. The position of the collecting plate 1695 with respect to the walls of the chamber 1654 can be adjusted using at least one support 1698.

Referring to FIG. 15 and FIGS. 16A-16C, an embodiment of the device and vacuum manifold can be used in the following manner. Cells in media are spun and the supernatant is removed. A suitable amount of RNase can then be added to a resuspension buffer (unless the resuspension buffer already includes a suitable amount of RNase) which may then be added to the pellet to resuspend the cells. A lysis buffer may then be added to the sample for no more than 5 minutes. The sample is then neutralized with addition of a neutralization buffer. The sample may then be introduced into the wells 1589 of multiwell clarifying plate 1594. Prior to preparing the devices for use, a binding tray 1591 can be positioned in a vacuum chamber 1552. The binding tray 1691 can be supported by at least one support 1698 which positions the binding tray 1691 in the optimal position with respect to the clarification tray 1694. The sample can then be introduced to each of the individual wells 1689 of the clarification tray 1594 and the clarification tray 1594 positioned in the top plate 1580.

FIG. 16A illustrates the devices positioned in the vacuum manifold 1650. The control unit 1568 can then be used to activate the vacuum manifold 1650. A sealing member 1653 can facilitate the formation of at least a partial vacuum seal between the vacuum chamber 1652 and the top plate 1680. The vacuum created in the chamber 1652 can then create a reduction in pressure between the clarification plate 1694 and the binding plate 1691 thereby sealing the clarification plate 1694 and the binding plate 1691 together. The vacuum can also manipulate the sample through the multiwell plates 1694, 1691. Under vacuum, the sample is clarified by the clarification plate 1694 200 and bound to a binding material in the binding plate 1691. The unwanted portion of the sample empties into either an empty space 1697 or a waste tray underneath the binding plate 1691. In some embodiments, the vacuum can be released and the clarification plate 1694 removed. The binding plate is then removed from the vacuum chamber and positioned in the top plate 1680, as shown in FIG. 16B. A waste tray 1682 can be positioned in the bottom of the vacuum chamber 1652 and the top plate 1680 and binding plate 1691 positioned over the waste tray 1682. At least one wash buffer can be introduced to the binding plate 1691. The sealing member 1653 then facilitates the formation of a seal between the top plate 1680 containing the binding plate 1691 and the vacuum chamber 1652. Vacuum is then applied to draw the wash buffer through the binding plate 1691. The wash buffer passes through the binding material and can be collected in the waste tray 1682. The vacuum can be released and the top plate 1680 removed from the vacuum chamber 1652.

Once the vacuum has be released and the top plate lifted from the vacuum chamber 1652, the top plate 1680 can then be positioned over an elution plate 1695. The elution plate 1695 can be positioned in the first vacuum chamber 1695 from which the waste tray 1682 has been removed. Alternative, the elution plate can be positioned in a second vacuum chamber 1654, as shown in FIG. 16C. The position of the elution plate can be adjusted using at least one support 1698 positioned in the vacuum chamber 1654. The elution plate 1695 can comprise at least one collection well 1696 for each binding well 1692. An elution buffer is then added to the binding plate 1692. A sealing member 1655 can facilitate the formation of at least a partial vacuum seal between the vacuum chamber 1654 and the top plate 1680. Upon application of a vacuum, the vacuum created can then cause the elution buffer to pass through the binding material in the binding plate 1691 thereby eluting at least one target molecule into a well 1696 of the elution plate 1695. Multiple aliquots of elution buffer can be added to the binding plate 1691 as desired. The vacuum can then be release, the top plate 1680 removed from the vacuum chamber 1654, the wells 1696 of the elution plate 1695 sealed and then removed from the vacuum chamber 1654.

### III. Methods

Further provided herein are methods of using the device with a vacuum manifold apparatus. A sample containing a desired molecule can be added to the clarification column of the device through the open end of the clarification column. Application of negative pressure to the device can manipulate the sample through the clarification column into the internal bore of the binding column. As the sample passes through the clarification column, large insoluble molecules can be prevented from passing through the outlet of the clarification column by the inner filter. The filtered sample can then pass from the outlet of the clarification column into the internal bore of the binding column. The sample can then come in contact with binding material located in the binding column. The binding material can bind the desired molecule or molecules while vacuum manipulates the rest of the liquid out of the device through the outlet aperture. The clarification column can then be removed. One or more washing solutions can be optionally added and forced by the vacuum to pass through the binding material and out of the device. The washing can ensure that any unbound molecules, impurities, or other debris are removed from the binding material. An eluting solution can then added to the binding column and, using the negative pressure, passed through the binding material to elute the desired molecule from the binding material. The eluate can then exit the outlet aperture and be collected. Multiple aliquots of eluting solution can be used.

In a further embodiment of the method, the suspension or liquid mixture is a cell lysate and the clarification column operates as a clarification column. The clarified lysate is passed through the binding material which binds a nucleic acid of interest. In some embodiments, the nucleic acid of interest is a plasmid DNA. The clarification column can then be removed and the bound DNA eluted and collected. The unique dual column design of the present invention enables clarification and binding in the same column in a single short (2-3 minute) vacuum step.

Also provided herein are methods for isolating at least one target molecule from a sample. In some embodiments, the method comprises: introducing a sample to a clarification/binding device; applying negative pressure to the clarification/binding device to clarify the sample and subsequently bind at least one target molecule to the binding material. In some embodiments of the method, the device can comprise a dual column clarification/binding device according to any of devices provided herein. Furthermore the method can further comprise removing the clarification column from the device. In some embodiments of the method, the binding column can be washed once. In some embodiments, the binding column can be washed more than once. In some embodiments of the method, the method can further comprise eluting the at least one target molecule bound to the binding material. The at least one eluted target molecule can be collected. In some embodiments, the at least one eluted target molecule can be collected in at least one collection tube. In some embodiments, the at least one eluted target molecule can be collected in a multiwell collection plate. In some embodiments of the method, the applying of negative pressure can further comprise inserting the device into a top plate on the manifold. In some embodiments, of the method, the applying negative pressure further comprises centrifuging the clarification/binding column device.

Yet another method provided herein comprises a method of isolating at least one target molecule comprising introducing a sample to clarification/binding device; applying negative pressure to the clarification/binding device to clarify the sample and bind at least one target molecule to the binding material; removing the clarification column from the device; and eluting the at least one target molecule from the device. In some embodiments, the introducing of the sample, applying negative pressure to the device, removing the clarification column from the device, and the eluting of the target molecule can all be performed using a single vacuum chamber of a vacuum manifold. Furthermore, the method can further comprise washing the binding column at least once after the removing the clarification column from the device. In some embodiments, the introducing, applying, and removing can be performed using a first chamber of a vacuum manifold. The devices can then be put in communication with the second chamber of the vacuum manifold. The eluting can then be performed using the second chamber of the vacuum manifold. Additionally, the method can further comprise washing the binding column at least once after the removing the clarification column. The washing step can be performed using the first vacuum chamber. In some embodiments of the method, the at least one eluted target molecule can be collected. In some embodiments, the at least one target molecule can be collected in a collection tube. The target molecule can be collected in any suitable container for collecting the eluted target molecule.

Yet another embodiment of the method provided herein is a method of isolating at least one target molecule from a sample using a clarification/binding device and a vacuum chamber manifold. In some embodiments, the method can comprise the steps of: introducing a sample to a clarification/binding device. The clarification/binding device can comprise a clarification column and a binding column. The clarification/binding device can then be inserted into an opening in a top plate. The top plate can then be positioned over a first vacuum chamber of the vacuum chamber manifold. Negative pressure supplied by the vacuum manifold can then be applied to the clarification/binding device to clarify the sample. The clarification column can clarify the sample. Immediately after the sample is clarified, the at least one target molecule present in the clarified sample can be bound inside the binding column. The at least one target molecule can be bound to a binding material present in the binding column. After the clarified sample has been passed through the device, the clarification column can be removed from the binding column. Negative pressure can be applied again to then elute the at least one target molecule from the binding column. In some embodiments of the method, the applying of negative pressure to clarify the sample and bind the target molecule or molecules and the applying of negative pressure to elute the bound at least one target molecule can be performed using the same vacuum chamber of a vacuum manifold. Alternatively, the application of negative pressure to clarify the sample and to bind the at least one target molecule can be performed using a first vacuum chamber of a vacuum chamber manifold. The application of negative pressure to elute the at least one target molecule can be performed using a second vacuum chamber of the vacuum chamber manifold. In some embodiments of the method, the method can further comprise washing the binding column at least once after removing the clarification column from the device. In some embodiments, the negative pressure supplied to clarify and bind the sample and/or to elute the target molecule from the binding column can be supplied using a centrifuge. In some embodiments of the method, the method can further comprise

Yet in another embodiment of the method, the method can comprise the steps of: inserting the clarification/binding device into an opening in the top plate of a vacuum manifold apparatus. In some embodiments, the top plate can then be positioned on the vacuum manifold apparatus. Alternatively, the top plate is already positioned on the vacuum manifold prior to the insertion of the clarification/binding devices. The sample can be introduced to the clarification/binding device. The clarification/binding device can comprise an clarification column and a binding column. Negative pressure supplied by the vacuum manifold can then be applied to the clarification/binding device to clarify the sample. The clarification column can clarify the sample. Immediately after the sample is clarified, the at least one target molecule present in the clarified sample can be bound inside the binding column. The at least one target molecule can be bound to a binding material present in the binding column. After the clarified sample has be passed through the device, the clarification column can be removed from the binding column. Negative pressure can be applied again to then elute the at least one target molecule from the binding column. In some embodiments of the method, the applying of negative pressure to clarify the sample and bind the target molecule or molecules and the applying of negative pressure to elute the bound at least one target molecule can be performed using the same vacuum chamber of a vacuum manifold. Alternatively, the application of negative pressure to clarify the sample and to bind the at least one target molecule can be performed using a first vacuum chamber of a vacuum chamber manifold. The application of negative pressure to elute the at least one target molecule can be performed using a second vacuum chamber of the vacuum chamber manifold. In some embodiments of the method, the method can further comprise washing the binding column at least once after removing the clarification column from the device. In some embodiments, the negative pressure supplied to clarify and bind the sample and/or to elute the target molecule from the binding column can be supplied using a centrifuge. In some embodiments of the method, the method can further comprise

### IV. Kits

Further provided herein are kits for isolating a target molecule of interest from a sample. In some embodiments, a kit for isolating a target molecule of interest can comprise a clarification/binding device for isolation of at least one target molecule from a sample comprising: a clarification column configured to receive the sample, the clarification column comprising at least one filter configured to filter at least one non-target molecule from the sample, and a binding column configured to receive the filtered sample from the clarification column, the binding column comprising a binding material for binding at least one target molecule, said clarification/binding device configured to filter the sample and bind the target molecule under negative pressure; and at least one elution buffer. In some embodiments, the elution buffer can comprise Tris hydrochloride. In some embodiments, the kit can further comprise a resuspension buffer. In some embodiments, the resuspension buffer can comprise TrisHCL and EDTA. Furthermore, the kit can comprise at least on wash buffer. In some embodiments, the kit can comprise a neutralizing buffer. In some embodiments of the kit, the kit can further comprise a lysis buffer. The lysis buffer can comprise sodium hydroxide and sodium dodecylsulfate. In a further embodiment of the kit, the kit can comprise a standard. In some embodiments of the kit, the kit can further comprising an RNase A stock solution. In some embodiments, the kit can further comprise a vacuum manifold apparatus.

Another embodiment of a kit provided herein is a kit for isolating a target molecule of interest comprising: a clarification/binding device for isolation of at least one target molecule from a sample comprising: a clarification column configured to receive the sample, the clarification column comprising at least one filter configured to filter at least one non-target molecule from the sample, and a binding column configured to receive the filtered sample from the clarification column, the binding column comprising a binding material for binding at least one target molecule, said clarification/binding device configured to filter the sample and bind the target molecule under negative pressure; at least one lysis buffer; at least one RNase stock solution; at least one resuspension buffer; at least one neutralization buffer; at least one wash buffer; and at least one elution buffer. In some embodiments, the kit can further comprise a vacuum manifold apparatus.

### V. Protocols

### Protocol 1—Preparation of a Cell Lysate for Mini Columns

Cells are harvested from an appropriate quantity of culture (for example, 50 ml of E. Coli) via centrifugation at >4,000×g for 10 minutes. The cells are resuspended in 250 μL of a resuspension buffer containing RNase A and inverted or vortexed to completely resuspend any cell clumps. Approximately 250 μL of a lysis buffer is added to the cells, and the tube capped and gently inverted between 5-10 times until the lysate is homogenous. Vortexing should not be used. The cells are incubated at room temperature for no more than 5 minutes. Approximately 250 μl of neutralization buffer is added to the tube, and the tube inverted 6-10 times until the precipitate is homogenous. Again, vortexing should not be used.

### Protocol 2—Purification and Elution Using Centrifugation

The cell lysate mixture from Protocol 1 is added to a binding column containing a clarification basket housed in a 2 mL collection tube. The mixture is allowed to incubate for 1 minute at room temperature to allow the precipitate to float to the surface. The mixture is then centrifuged for 2 minutes at 2,100 rpm. The clarification column is discarded and the flow-through is decanted and discarded to waste. The binding column is placed in a 2 mL collection tube. 750 μL of a first wash buffer is added and the collection tube centrifuged for 1 minute at 10,000 rpm. The flow-through is decanted to waste and the outer binding column is transferred to a new 2 mL collection tube. Approximately 250 μL of a second wash buffer is added and the column centrifuged for 1 minute at 10,000 rpm and the flow-through decanted.

The binding column is transferred to a clean 1.7 mL collection tube and approximately 50-100 μL of an elution buffer (10 mM Tris, pH 8.5) is added. The column is incubated for 1 minute and centrifuged for 1 minute at 10,000 rpm. The binding column is discarded and the eluted DNA is stored at −20° C.

### Protocol 3—Purification Using Vacuum and Elution Using Centrifugation

The cell lysate mixture from Protocol 1 is added to a binding column containing a clarification column and the column placed on a luer lock fitting on an appropriate vacuum manifold. The lysate is incubated for 1 minute at room temperature to allow precipitate to float to the surface. A vacuum is applied to the column (15-20 inches Hg) until the lysate passes through the clarification column, approximately 2-3 minutes. The vacuum is released and the clarification column is discarded. Approximately 750 μL of a first wash buffer is added to the column and the vacuum applied until the first wash buffer passes through the column, approximately 1 minute. Approximately 250 μL of a second wash buffer is added to the column and the vacuum applied until the second wash buffer passes through the column, approximately 1 minute. This lysate clarification and washing procedure can, for example, be conducted employing a vacuum manifold of this invention.

The binding column is transferred to a clean 1.7 ml collection tube and approximately 50-100 μl of an elution buffer (10 mM Tris, pH 8.5) is added. The column is incubated for 1 minute and centrifuged for 1 minute at 10,000 rpm. The binding column is discarded and the eluted DNA is stored at −20° C.

Protocol 4—Purification and Elution Using the Mini Dual Column Devices of this Invention Under Vacuum

Using a dual column collection/elution device as illustrated in FIG. 1 and a dual chamber vacuum manifold as illustrated in FIGS. 10 and 11A-B a vacuum can be used for both the clarification/binding steps as well as the elution steps, thereby eliminating the need for centrifugation. For this procedure, one or more dual column devices are placed in a “mini prep” top plate of the vacuum manifold with any unoccupied openings blocked with rubber stoppers. The top plate is positioned over a vacuum chamber containing a waste tray. The cell lysate from Protocol 1 is added to each dual column device and allowed to incubate for 1 minute at room temperature to allow precipitate to float to the surface. A vacuum is applied to the vacuum chamber (15-20 inches Hg) until the lysate passes through the clarification column of each dual column device (approximately 2-3 minutes). The vacuum is released and the clarification column is discarded. Approximately 750 μL of a first wash buffer is added to the binding column for each dual column device and vacuum is applied until the first wash buffer passes through the column, approximately 1 minute. Approximately 250 μL of a second wash buffer is added to the binding column for each dual column device and vacuum applied until the second wash buffer completely passes through the column and the binding membrane becomes dry, approximately 2 minutes.

The vacuum is released and the top plate of the manifold with the remaining components of the dual column devices in place in the openings is transferred to a vacuum chamber containing an elution tray. The elution tray contains one or more clean 1.7 mL collection tubes. Approximately 50-100 μL of a DNA elution buffer (10 mM Tris, pH 8.5) is added to each column and incubated for 1 minute. A vacuum is applied to the vacuum chamber (15-20 inches Hg) for 2 minutes to allow the elution buffer to completely pass through the binding membrane and into the collection tubes before releasing the vacuum. The top plate is then removed, the columns discarded and the eluted DNA samples in the collection tubes from the elution tray are stored at −20° C.

### Protocol 5—Preparation of Cell Lysate for Midi and Maxi Columns

Cells are harvested from an appropriate quantity of culture via centrifugation at >4,000×g for 10 minutes. The cells are resuspended with 5 mL (midi preparation) or 7 mL (maxi preparation) of a resuspension buffer containing RNase A and inverted repeatedly or vortexed to completely resuspend any cell clumps. Approximately 5 mL (midi preparation) or 7 mL (maxi preparation) of a lysis buffer are added, and the cells gently inverted at least 10 times until the lysate is homogenous. The reduced volume nature of the preparation system requires adequate mixing at the lysis stage to release sufficient plasmid DNA, however vortexing should not be used. The preparation is incubated at room temperature for no more than 5 minutes. Approximately 5 mL (midi preparation) or 7 ml (maxi preparation) of a neutralization buffer is added and the preparation inverted 6-10 times until the precipitate is homogenous. Vortexing should not be used.

### Protocol 6—Purification and Elution Using Centrifugation for Midi and Maxi Preparations

In one procedure where centrifugation is used for clarification/binding and elution, an assembled midi or maxi preparation column is placed into a 50 mL conical tube. The cell lysate from Protocol 5 is placed in the column and incubated for 3-5 minutes at room temperature to allow precipitate to float to the surface. The column is centrifuged for between 1 minute and 5 minutes at >2,250×g in a swinging bucket centrifuge. The inner clarification column is discarded and the flow-through decanted to waste. The outer binding column is placed in a 50 mL conical tube and approximately 15 mL of a first wash buffer is added. The column is centrifuged for 1 minute at >2,250×g in a swinging bucket centrifuge. The flow-through is decanted to waste and the outer binding column placed into 50 mL conical tube. Approximately 15 mL of a second wash buffer is added and the column centrifuged for 1 minute at >2,250×g in a swinging bucket centrifuge. The flow-through is decanted to waste and the binding column transferred to a clean 50 mL conical tube.

Approximately 0.5 mL (midi preparation) or 2 mL (maxi preparation) of elution buffer (10 mM Tris HCl, pH 8.5) is added to the tube and incubated for 1 minute. The tube is centrifuged for 1 minute at >2,250×g in a swinging bucket centrifuge and the eluate collected.

### Protocol 7—Purification Using Vacuum and Elution Using Centrifugation for Midi and Maxi Preparations

In one procedure where vacuum is used for lysate clarification, binding of nucleic acid, and elution, an assembled midi or maxi preparation column is placed into a luer lock fitting on an appropriate vacuum manifold. (For example, a dual chamber vacuum manifold of the present invention can be used.) The cell lysate from Protocol 5 is placed in the column and incubated for 3-5 minutes at room temperature to allow precipitate to float to the surface. A vacuum is applied to the column (15-20 inches Hg) until the lysate passes through the inner clarification column, approximately 3-5 minutes. The vacuum is released and the inner clarification column is discarded. Approximately 15 mL of a first wash buffer is added to the column and a vacuum applied until the wash buffer passes through the column, approximately 1 minute. Approximately 15 mL of a second wash buffer is added to the column and a vacuum applied until the wash buffer passes through the column.

The binding column is transferred to a clean 50 ml conical tube. Approximately 0.5 mL (midi preparation) or 2 mL (maxi preparation) of DNA elution buffer (10 mM Tris HCl, pH 8.5) is added to the tube and incubated for 1 minute. The tube is centrifuged for 1 minute at >2,250×g in a swinging bucket centrifuge and collected.

### Protocol 8—Purification and Elution Using the Dual Column Devices of the Invention Under Vacuum for Midi and Maxi Preparations

Using the dual column devices as illustrated in FIG. 2 and vacuum manifolds as illustrated in FIGS. 13 and 14A and B, a vacuum can be used for both the clarification/binding steps as well as the elution steps for both midi and maxi preparations, thereby eliminating the need for centrifugation. For this procedure, one or more midi or maxi sized dual column devices are placed in a “midi/maxi” top plate with any remaining openings blocked with rubber stoppers. The top plate is placed over a vacuum chamber containing a waste tray. The cell lysate from Protocol 5 is added to each dual column device and allowed to incubate for 1 minute at room temperature to allow precipitate to float to the surface. A vacuum is applied to the vacuum chamber (15-20 inches Hg) until the lysate passes through the clarification column for each dual column device, approximately 2-3 minutes. The vacuum is released and the clarification column removed and discarded. Approximately 15 mL of a first wash buffer is added to the binding column for each dual column device and the vacuum applied until the first wash buffer passes through the column, approximately 1 minute. Approximately 15 mL of a second wash buffer is added to the binding column for each dual column device and the vacuum applied until the first wash buffer passes through the column, approximately 1 minute.

The vacuum is released and the top plate is transferred to a vacuum chamber containing an elution tray carrying one or more clean 2 mL or larger collection tubes. Approximately 0.5 mL (midi preparation) or 1.75 mL (maxi preparation) of a DNA elution buffer (10 mM TrisHCl, pH 8.5) is added to each column and incubated for 1 minute. A vacuum is applied to the vacuum chamber (−15-20 inches Hg) for 2 minutes to allow the elution buffer to completely pass through the binding membrane and into the collection tubes before releasing the vacuum. The top plate is removed, the columns discarded and the eluted DNA samples from the elution tray are stored at −20° C.

### Protocol 9—Manifold Operation for Purification and Elution of Mini Preparations

For the clarification/binding and elution procedures for mini sized preparations using a vacuum described herein, a vacuum manifold of the present invention can be utilized. The connector or spigot of the control unit of the vacuum manifold is attached to a vacuum source using vacuum tubing. The primary valve and each of the chamber valves are initially in a closed position so that neither vacuum chamber is connected to the vacuum source. The fine control valve and quick release valve also begin closed. The chamber valve for the first vacuum chamber is opened and the vacuum source turned on. The pressure gauge can measure from 0-30 inches of Hg. The recommended operating range for this vacuum manifold extends up to and including 20 inches of Hg.

A waste tray is inserted into the first vacuum chamber and a mini preparation top plate is placed over the first vacuum chamber. One or more mini preparation sized dual column devices of the present invention are inserted into the openings of the top plate and the remaining openings are sealed with rubber stoppers. The cell lysate is added to each of the dual column devices and a vacuum is applied to the chamber by opening the primary valve. The vacuum is maintained until the lysate passes through the clarification column. The primary valve is closed and the vacuum released by opening the quick release valve until the vacuum reading on the pressure gauge is zero.

The clarification column is then removed. Approximately 750 μL of a first wash buffer is added to the binding column for each dual column device and the vacuum (15-20 inches Hg) is applied by opening the primary valve until the first wash buffer passes through the column. The primary valve is closed and the vacuum released until the pressure gauge gives a reading of zero. Approximately 250 μL of a second wash buffer is added to the binding column for each dual column device and the vacuum applied by opening the primary valve. The vacuum is applied for approximately 2 minutes to allow wash buffer to completely pass and dry the membrane. The primary valve is closed and the vacuum released.

A collection rack containing one or more collection tubes is inserted into the second vacuum chamber. The collection rack contains collection tubes sited at positions corresponding to those at which columns are placed in the mini preparation top plate. The top plate is transferred to the second vacuum chamber and the chamber valve to the first vacuum chamber is closed while the chamber valve to the second vacuum chamber is opened. Approximately 50-100 μL of an elution buffer (10 mM Tris, pH 8.5) is added to each column and incubated for 1 minute. A vacuum is applied to the vacuum chamber (15-20 inches Hg) by opening the primary valve for 2 minutes to allow the elution buffer to completely pass through the binding membrane and into the collection tubes. The primary valve is closed and the vacuum released. The top plate is removed, the columns discarded and the eluted DNA samples from the elution tray are stored at −20° C.

If a more controlled rate of elution is desirable, then after the elution buffer is added to the columns, the valve to the second chamber is closed and the fine control valve fully opened. The primary valve is opened to allow the vacuum to access the control unit and wait until the pressure gauge reads zero. The chamber valve to the second vacuum chamber is opened and the fine control valve is slowly closed until the desired vacuum pressure is obtained. Once the desire pressure is obtained, the vacuum is applied for complete elution, about 2 min.

### Protocol 10—Manifold Operation for Purification and Elution of Midi and Maxi Preparations

For the clarification/binding and elution procedures for midi and maxi sized preparations applying vacuum as described herein, a vacuum manifold of the present invention can be utilized. The connector or spigot of the control unit of the vacuum manifold is attached to a vacuum source using vacuum tubing. The primary valve and each of the chamber valves are initially in a closed position so that neither vacuum chamber is connected to the vacuum source. The fine control valve and quick release valve are also closed. The chamber valve for the first vacuum chamber is opened and the vacuum source turned on. Recommended operating range for this vacuum manifold is not greater than 20 inches Hg.

A waste tray is inserted into the first vacuum chamber and a midi/maxi preparation top plate is positioned over the first vacuum chamber. One or more midi/maxi preparation sized dual column devices of the present invention are inserted into the openings of the top plate and the remaining openings are sealed with rubber stoppers. Cell lysate is added to each of the dual column devices and vacuum is applied to the first chamber by opening the primary valve. The vacuum is maintained until the lysate passes through the clarification column. The primary valve is closed and the vacuum released by opening the quick release valve until the vacuum reading on the pressure gauge is zero.

Approximately 15 mL of a first wash buffer is added to the binding column for each dual column device and the vacuum (15-20 inches Hg) is applied by opening the primary valve until the first wash buffer passes through the column. The primary valve is closed and the vacuum released until the pressure gauge gives a reading of zero. Approximately 15 mL of a second wash buffer is added to the binding column for each dual column device and the vacuum applied by opening the primary valve. The vacuum will be applied for approximately 2 minutes to allow wash buffer to completely pass and dry the membrane. The primary valve is closed and the vacuum released.

A collection rack containing one or more collection tubes is inserted into the second vacuum chamber. The collection rack contains collection tubes sited at positions corresponding to those at which columns are placed in the midi/maxi preparation top plate. The top plate is transferred to the second vacuum chamber and the chamber valve to the first vacuum chamber is closed while the chamber valve to the second vacuum chamber is opened. Approximately 0.5-2 mL of an elution buffer (10 mM Tris, pH 8.5) is added to each column and incubated for 1 minute. A vacuum is applied to the vacuum chamber (15-20 inches Hg) by opening the primary valve. The vacuum is maintained until elution buffer completely passes through the binding membrane and into the collection tubes (about 2 min.). The primary valve is then closed and the vacuum released. The top plate is removed, the columns discarded and the eluted DNA samples from the elution tray are stored at −20° C.

If a more controlled rate of elution is desirable, then after the elution buffer is added to the columns, the chamber valve to the second chamber is closed and the fine control valve fully opened. The primary valve is opened to allow the vacuum to access the control unit and until the pressure gauge reads zero. The chamber valve to the second vacuum chamber is opened and the fine control valve is slowly closed, until the desired vacuum pressure is obtained. Once the desire pressure is obtained, the vacuum is maintained for complete elution (about 2 min.).

### Protocol 11—Manifold Operation for Purification Using Luer Lock Columns

For the clarification/binding and elution procedures for columns and top plates utilizing luer connectors, a vacuum manifold of the present invention can be utilized. The connector or spigot of the control unit of the vacuum manifold is attached to a vacuum source using vacuum tubing. The primary valve and each of the chamber valves are initially in a closed position, so that neither vacuum chamber is connected to the vacuum source. The fine control valve and quick release valve also begin closed. The chamber valve for the first vacuum chamber is opened and the vacuum source turned on. The recommended operating range for this vacuum manifold is not greater than 20 inches of Hg.

A waste tray is inserted into the first vacuum chamber and a luer top is positioned over the first vacuum chamber. One or more dual column devices having luer nozzles are inserted into the luer connector openings of the top plate and the remaining luer taps are closed. The cell lysate is added to each of the dual column devices and a vacuum is applied to the chamber by opening the primary valve. The vacuum is maintained until the lysate passes through the clarification column. The primary valve is closed and the vacuum released by opening the quick release valve until the vacuum reading on the pressure gauge is zero.

The clarification column is removed prior to washing. Approximately 15 mL of a first wash buffer is added to the binding column for each dual column device and the vacuum (15-20 inches Hg) is applied by opening the primary valve until the first wash buffer passes through the column. The primary valve is closed and the vacuum released until the pressure gauge gives a reading of zero. Approximately 15 mL of a second wash buffer is added to the binding column for each dual column device and the vacuum applied by opening the primary valve. The vacuum will be applied for approximately 2 minutes to allow wash buffer to completely pass and dry the membrane. The primary valve is closed and the vacuum released.

### Protocol 12—Manifold Operation for Purification and Elution Using Multiwell Plates

For the clarification/binding and elution procedures for multiwell plates, a vacuum manifold of the present invention can be utilized. The connector or spigot of the control unit of the vacuum manifold is attached to a vacuum source using vacuum tubing. The primary valve and each of the chamber valves are initially in a closed position so that neither vacuum chamber is connected to the vacuum source. The fine control valve and quick release valve also begin closed. The chamber valve for the first vacuum chamber is opened and the vacuum source turned on. The recommended operating range for this vacuum is not greater than 20 inches of Hg.

A 96 well binding plate is inserted in a multiwell plate support placed at the bottom of a vacuum chamber of the vacuum manifold. A 96 well top plate is positioned over the vacuum chamber and a 96 well clarification plate is placed onto the 96 well top plate such that the nozzles at the bottom of the clarification plate align with corresponding wells on the binding plate and a good seal is obtained. If the plate is not seated correctly, a vacuum seal will not form. The lysate is transferred to each of the desired wells in the clarification plate. Unused wells in the plate are covered in foil to assist generation of vacuum for remaining sample sites. A vacuum (15-20 in Hg) is applied, by opening the primary valve, until the lysate passes through the 96 well clarification plate and into the binding plate at the bottom of the vacuum chamber, approximately 1 minute. The primary valve is closed and the vacuum released by opening the quick release valve until the vacuum reading on the pressure gauge is zero.

The clarification plate is discarded and the binding plate is removed from the first vacuum chamber. A waste tray is placed in the bottom of the first vacuum chamber. The 96 well top plate is positioned over the vacuum chamber and the binding plate is placed onto the top plate such that a good seal is formed between the binding plate and top plate. The lysate is then pulled through the filter. Approximately 900 μL of a first wash buffer is added to each desired well the binding plate and the unused wells blocked with foil. The vacuum (15-20 inches Hg) is applied by opening the primary valve until the first wash buffer passes through the binding plate and into the waste tray. The primary valve is closed and the vacuum released until the pressure gauge gives a reading of zero. Approximately 900 μL of a second wash buffer is added to each well and the vacuum applied by opening the primary valve for 3-5 minutes to allow the wash buffer to completely pass through the binding column and dry the binding membrane. The primary valve is closed and the vacuum released.

A 96 well elution collection plate is placed in the second vacuum chamber of the vacuum manifold. The collection plate is supported and centered in the vacuum chamber with a support, collar or a positioning block. The 96 well top plate and binding plate are positioned over the second vacuum chamber. The chamber valve to the first vacuum chamber is closed and the chamber valve to the second vacuum chamber is opened. Approximately 50-100 μL of an elution buffer (10 mM Tris, pH 8.5) is added to each of the used wells in the binding plate and the plate incubated for 1 minute. A vacuum is applied to the vacuum chamber (15-20 inches Hg) by opening the primary valve and maintained to allow the elution buffer to completely pass through the binding membrane and into the collection tubes (about 2 min.). The primary valve is closed and the vacuum released. The top plate is removed, the binding plate discarded and the collection plate having the eluted DNA samples is removed from the elution tray and stored at −20° C.

If a more controlled rate of elution is desirable, then after the elution buffer is added to the columns the chamber valve to the second chamber is closed and the fine control valve fully opened. The primary valve is opened to allow the vacuum to access the control unit and equalize the pressure. The chamber valve to the second vacuum chamber is opened and the fine control valve is slowly closed until the desired vacuum pressure is met. Once the desired pressure is met, allow the vacuum to continue for 2 minutes for complete elution.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description.

All references cited in this application are hereby incorporated in their entireties by reference to the extent that they are not inconsistent with the disclosure in this application. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques specifically described herein are intended to be encompassed by this invention.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure.

What is claimed is:

1. A dual column clarification/binding device for isolation of at least one target molecule from a sample comprising:
a clarification column configured to receive the sample, the clarification column comprising at least one filter configured to filter at least one non-target molecule from the sample; and
a binding column configured to receive the filtered sample from the clarification column, the binding column comprising a binding material for binding at least one target molecule, said clarification/binding device configured to filter the sample and bind the at least one target molecule under negative pressure.

2. The device of claim 1 wherein the binding column further comprises at least one support structure in communication with the binding material, the support structure configured to restrict movement of the binding material.

3. The device of claim 2 wherein the at least one support structure is a frit.

4. The device according to claim 1 wherein the binding column further comprises at least one locking ring configured to restrict the movement of the binding material.

5. The device according to claim 1 wherein the binding material is configured to bind a nucleic acid.

6. The device according to claim 1 wherein the nucleic acid is deoxyribonucleic acid.

7. The device of claim 6 wherein the deoxyribonucleic acid is plasmid DNA or a fragment thereof, or genomic DNA, or a fragment thereof.

8. The device according to claim 1 wherein the binding material is at least one of silica, glass fiber, nitrocellulose, a charge switch membrane, an anion exchange matrix, and derivatized glass fiber, or combination thereof.

9. The device according to claim 1 wherein the binding membrane comprises at least two layers, a first layer and a second layer.

10. The device according to claim 1 wherein the first layer and the second layer have a pore size in the range of between 0.5 μm to 5 μm.

11. The device according to claim 1 wherein the binding material comprises multiple layers.

12. The device according to claim 1 wherein the binding material comprises a pore size in the range of between 0.6 μm to 2 μm.

13. The device according to claim 1 wherein the binding material comprises a pore size in the range of between 0.7 μm and 1 μm.

14. The device according to claim 1 wherein the filter is configured to clarify the sample.

15. The device according to claim 1 wherein the filter comprises at least two layers, a first layer and a second layer.

16. The device of claim 15 wherein the first layer and the second layer are the same structure.

17. The device of claim 15 wherein the first layer and the second layer are two separate structures.

18. The device of claim 15 wherein the filter is an asymmetric filter.

19. The device of claim 15 wherein the first layer has a pore size in the range of between 5 μm and 20 μm and the second layer has a pore size in the range of between 30 μm and 100 μm.

20. The device according to claim 15 wherein the first layer has a pore size in the range of between 5 μm and 7 μm and the second layer has a pore size in the range of between 40 μm and 45 μm.

21. The device according to claim 1 wherein the filter comprises more than two layers.

22. The device according to claim 1 wherein the filter is a rigid structure.

23. The device of claims 1 wherein the filter is a two layer polyethylene frit.

24-26. (canceled)

27. The device according to claim 1 wherein the clarification column further comprises a locking ring.

28. The device of claim 1 wherein the device is configured to elute the target molecule from the binding material under negative pressure.

29. The device of claim 28 wherein the negative pressure is created by a vacuum force.

30. The device of claim 28 wherein the negative pressure is created by centripetal force.

31. The device of claim 1 wherein the clarification column further comprises an clarification column depth stop configured to limit the depth of insertion of the clarification column into the binding column.

32. The device of claim 1 wherein the binding column further comprises a binding column depth stop, the binding column depth stop configured to limit the insertion of the device into a centrifuge tube.

33. (canceled)

34. The device of claim 1 wherein the binding column further comprises a luer nozzle.

35. An apparatus for the isolation of a target molecule from a sample comprising:
a top plate configured to hold at least one container for isolating at least one target molecule from a sample;
a vacuum manifold comprising a first vacuum chamber; and
a second vacuum chamber;
wherein the top plate is configured to be used with one or both of the first vacuum chamber and the second vacuum chamber of the vacuum manifold.

36. The apparatus of claim 35 wherein the at least one container comprises a clarification/binding device according to claim 1.

37. The apparatus of claim 35 further comprising a removable waste tray.

38. The apparatus according to claim 35 further comprising a removable elution tray.

39. The apparatus of claim 38 wherein the removable elution tray is configured to hold at least one collection tube.

40. The apparatus of claim 38 wherein the elution tray is configured to hold a multiwell collection plate.

41. The apparatus of claim 40 wherein the multiwell plate is a 96-well multiwell plate.

42. (canceled)

43. The apparatus according to claim 35 wherein the top plate is a mini column top plate.

44. The apparatus according to claim 35 wherein the top plate is a midi/maxi column top plate.

45. The apparatus of claim 44 further comprising a stop plate.

46. (canceled)

47. The apparatus according to claim 35 further comprising a sealing member configured to facilitate forming a seal between the top plate and either the first vacuum chamber or the second vacuum chamber.

48. The apparatus of claim 47 wherein the seal is at least a partial seal.

49. The apparatus of claim 47 wherein the sealing member is located on the vacuum manifold.

50. The apparatus of claim 47 wherein the sealing member is located on the top plate.

51. The apparatus according to claim 35 wherein the apparatus comprises at least a third vacuum chamber.

52. The apparatus according to claim 35 further comprising more than one top plate.

53. The apparatus according to claim 35 further comprising a vacuum control unit.

54. The apparatus according to claim 35 wherein the vacuum control unit comprises at least one of a fine control valve, a quick release valve, and a pressure gauge.

55. A method of isolating at least one target molecule from a sample comprising the steps of:
introducing a sample to a clarification/binding device; and
applying negative pressure to the clarification/binding device, to clarify the sample and subsequently bind at least one target molecule to the binding material.

56. (canceled)

57. The method according to claim 55 further comprising removing the clarification column from the device.

58. The method according to claim 55 further comprising washing the binding column at least once.

59. The method according to claim 55 further comprising:
eluting the at least one target molecule; and
collecting the eluted at least one target molecule.

60. (canceled)

61. The method of claim 55 wherein the applying negative pressure further comprises inserting the dual column device into a top plate of a vacuum manifold.

62. The method according to claim 55 wherein the applying negative pressure further comprises centrifuging the dual column device.

63. A method of isolating at least one target molecule from a sample comprising the steps of:
introducing a sample to a clarification/binding device;
applying negative pressure to the clarification/binding device to clarify the sample and bind at least one target molecule to the binding material;
removing the clarification column from the dual column device; and
eluting the at least one target molecule from the dual column device.

64. The method of claim 63 wherein the introducing, applying, removing, and eluting are performed using a single vacuum chamber of a vacuum manifold.

65. (canceled)

66. The method of claim 63 wherein the introducing, applying, removing are performed using a first chamber of a vacuum manifold and the eluting is performed using a second chamber of the vacuum manifold.

67. The method of claim 66 further comprising washing the binding column at least once after the removing the clarification column, wherein the washing step is performed using the first vacuum chamber.

68-76. (canceled)

77. A kit for isolating a target molecule of interest comprising:
a dual column clarification/binding device for isolation of at least one target molecule from a sample comprising:
a clarification column configured to receive the sample, the clarification column comprising at least one filter configured to filter at least one non-target molecule from the sample; and
a binding column configured to receive the filtered sample from the clarification column, the binding column comprising a binding material for binding at least one target molecule,
wherein said dual column clarification/binding device configured to filter the sample and bind the target molecule under negative pressure; and
at least one elution buffer.

78. The kit of claim 77 further comprising at least one of the following: at least one resuspension buffer, at least one wash buffer, at least one neutralizing buffer, at least one lysis buffer, at least one RNase A stock solution or any combinations thereof.

79. The kit of claim 78 wherein the resuspension buffer comprises TrisHCL and EDTA.

80-82. (canceled)

83. The kit of claim 78 wherein the lysis buffer comprises sodium hydroxide and sodium dodecylsulfate.

84. (canceled)

85. The kit of claim 77 further comprising a vacuum manifold apparatus.

86. The kit of claim 77 wherein the elution buffer comprises Tris hydrochloride.

87-88. (canceled)
